(19) United States
(12) Patent Application Publication
(10) Pub. No.: US 2026/0007498 A1
(43) Pub. Date: Jan. 8, 2026

(54) LIGHTGUIDE PROJECTOR

(71) Applicant: Align Technology, Inc., San Jose, CA (US)

(72) Inventors: Nadav Fain, Petach Tikva (IL); Eliahou Franklin Nizard, Jerusalem (IL)

(21) Appl. No.: 19/259,688

(22) Filed: Jul. 3, 2025

Related U.S. Application Data
(60) Provisional application No. 63/668,661, filed on Jul. 8, 2024.

(51) Int. Cl. A61C 9/00; G02B 23/24

(52) U.S. Cl. CPC A61C 9/0053; G02B 23/2461

(57) ABSTRACT

An intraoral scanner includes a probe housing disposed at a distal end of an elongate wand. The probe housing forms an interior volume. The intraoral scanner further includes a lightguide projector that includes a light source configured to generate light. The light source is disposed in the interior volume. The lightguide structure is configured to receive the light from the light source. The light is to propagate through the lightguide structure via internal reflections. The lightguide projector is configured to cause the light to exit the lightguide structure to illuminate a mouth of a patient.

### RELATED APPLICATIONS

This application claims priority to U.S. Provisional Patent Application 63/668,661, filed Jul. 8, 2024, the contents of which are hereby incorporated by reference in their entirety.

### TECHNICAL FIELD

Embodiments of the present disclosure relate to the field of dentistry and, in particular, to lightguide projectors.

### BACKGROUND

A dental site of a patient is to be measured accurately and studied carefully so that dental procedures can be performed.

### SUMMARY

In a first implementation, an intraoral scanner includes: a probe housing disposed at a distal end of an elongate wand, the probe housing forming an interior volume; and a lightguide projector comprising: a light source configured to generate light, the light source disposed in the interior volume; and lightguide structure configured to receive the light from the light source, wherein the light is to propagate through the lightguide structure via internal reflections, wherein the lightguide projector is configured to cause the light to exit the lightguide structure to illuminate a mouth of a patient.

A second implementation may further extend the first implementation. In the second implementation, the intraoral scanner includes an in-coupler structure configured to receive the light, wherein the in-coupler structure is disposed between the light source and the lightguide structure.

A third implementation may further extend the first or second implementations. In the third implementation, the in-coupler structure is one or more of a prism, a diffractive optical element (DOE), or an edge coupler.

A fourth implementation may further extend any of the first through third implementations. In the fourth implementation, the intraoral scanner further includes a lens disposed between the light source and the in-coupler structure, wherein the lens is to focus the light.

A fifth implementation may further extend any of the first through fourth implementations. In the fifth implementation, the intraoral scanner further includes a micro-lens array (MLA) coupled to the lightguide structure, wherein the MLA is to cause the light to be diffracted and split to an array of spots to be provided into the mouth of the patient.

A sixth implementation may further extend any of the first through fifth implementations. In the sixth implementation, the lightguide structure is made of a material that is transparent to the wavelength of the light, wherein the material has a refractive index higher than surrounding environment.

A seventh implementation may further extend any of the first through sixth implementations. In the seventh implementation, the lightguide projector comprises a curved mirror that is configured to focus the light substantially perpendicularly to an elongated axis of the lightguide structure and focus the light outside of the lightguide structure.

An eighth implementation may further extend any of the first through seventh implementations. In the eighth implementation, the curved mirror is a reflective coating disposed on the lightguide structure.

A nineth implementation may further extend any of the first through eighth implementations. In the nineth implementation, the lightguide projector comprises a partially reflecting curved surface embedded within the lightguide structure, wherein the partially reflecting curved surface is configured to cause the light to exit the lightguide structure to illuminate the mouth of the patient.

A tenth implementation may further extend any of the first through nineth implementations. In the tenth implementation: the lightguide projector comprises a reflecting portion configured to cause the light to exit the lightguide structure to illuminate the mouth of the patient; the reflecting portion is configured to break the internal reflections of the light within the lightguide structure; the reflecting portion is at least one of prism or an angle-dependent geometrical structure; and the reflecting portion is of a different refractive index than the lightguide structure or may be part of the lightguide structure.

An eleventh implementation may further extend any of the first through tenth implementations. In the eleventh implementation, the lightguide projector comprises a grating that is a two-dimensional array of structures integrated within the lightguide structure, wherein the grating is configured to cause the light to exit the lightguide structure to illuminate the mouth of the patient.

A twelfth implementation may further extend any of the first through eleventh implementations. In the twelfth implementation, the grating is formed by E-beam lithography, ultraviolet (UV) lithography, nanoimprint, ion doping, or photo-sensitive polymer.

A thirteenth implementation may further extend any of the first through twelfth implementations. In the thirteenth implementation, the grating is a focusing grating coupler (FGC) that is an array of curved and chirped grooves.

A fourteenth implementation may further extend any of the first through thirteenth implementations. In the fourteenth implementation, the lightguide projector comprises a grating or a metasurface that is configured to focus the light and split the light into a pattern.

A fifteenth implementation may further extend any of the first through fourteenth implementations. In the fifteenth implementation, the lightguide projector comprises: a second light source configured to provide second light via the lightguide structure to the mouth of the patient.

In a sixteenth implementation, an intraoral scanner includes: a probe housing disposed at a distal end of an elongate wand, the probe housing forming an interior volume; and a lightguide projector comprising: a light source configured to generate light, the light source disposed in the interior volume, the light being one or more of white light illumination, coherent light illumination, or near-infrared illumination; and lightguide structure configured to receive the light from the light source, wherein the light is to propagate through the lightguide structure and is to exit the lightguide structure to illuminate a mouth of a patient.

A seventeenth implementation may further extend the sixteenth implementation. In the seventeenth implementation, a reflecting portion of the lightguide projector is configured to focus the light substantially perpendicularly to the elongated axis of the lightguide structure and focus the light outside of the lightguide structure.

In an eighteenth implementation, an intraoral scanner includes: a probe housing disposed at a distal end of an elongate wand, the probe housing forming an interior volume; and a lightguide projector comprising: a first light source configured to generate first light; and a second light source configured to generate second light, the first light source and the second light source disposed in the interior volume; and lightguide structure configured to receive the first light from the first light source and the second light from the second light source, wherein the first light and the second light are to propagate through the lightguide structure via corresponding internal reflections and are to exit the lightguide structure to illuminate a mouth of a patient.

A nineteenth implementation may further extend the eighteenth. In the nineteenth implementation, the first light and the second light are different types of light that have one or more of different wavelengths, different angles, or different spatial distributions.

A twentieth implementation may further extend the eighteenth or nineteenth implementations. In the twentieth implementation, the first light is to exit the lightguide structure at a first portion of the lightguide structure, and wherein the second light is to exit the lightguide structure at a second portion of the lightguide structure that is different from the first portion of the lightguide structure. A twenty-first implementation may further extend any of the eighteenth through twentieth implementations. In the twenty-first implementation, a first portion of the first light is to exit the lightguide structure via a first out-coupler of the lightguide projector, and wherein a second portion of the first light is to further propagate through the lightguide structure and exit the lightguide structure via a second out-coupler of the lightguide projector.

A twenty-second implementation may further extend any of the eighteenth through twenty-first implementations. In the twenty-second implementation: the first out-coupler is a first grating, a first metasurface, a first reflecting surface, or a first lens array; and the second out-coupler is a second grating, a second metasurface, a second reflecting surface, or a second lens array.

A twenty-third implementation may further extend any of the eighteenth through twenty-second implementations. In the twenty-third implementation, the first light is to exit the lightguide structure at a first portion of the lightguide structure, and wherein the second light is to exit the lightguide structure at the first portion of the lightguide structure.

### BRIEF DESCRIPTION OF THE DRAWINGS

Embodiments of the present disclosure are illustrated by way of example, and not by way of limitation, in the figures of the accompanying drawings.

FIG. 1 illustrates a system for performing intraoral scanning and/or generating a virtual three-dimensional (3D) model of a dental site, according to certain embodiments.

FIG. 2A is a schematic illustration of a handheld intraoral scanner with a plurality of cameras disposed within a probe at a distal end of the intraoral scanner, according to certain embodiments.

FIGS. 2B-2C include schematic illustrations of positioning configurations for cameras and structured light projectors of an intraoral scanner, according to certain embodiments.

FIG. 2D is a chart depicting a plurality of different configurations for the position of structured light projectors and cameras in a probe of an intraoral scanner, according to certain embodiments.

FIGS. 3A-O illustrate side views of components of intraoral scanners, according to certain embodiments.

FIGS. 4A-I illustrate views of components of intraoral scanners, according to certain embodiments.

FIG. 5 illustrates a block diagram of an example computing device, according to certain embodiments.

### DETAILED DESCRIPTION

Described herein are devices, systems, and methods associated with lightguide projectors of intraoral scanners.

A dental site of a patient is to be measured accurately and studied carefully so that dental procedures can be performed. For example, in prosthodontic procedures designed to implant a dental prosthesis in the oral cavity, the dental site at which the prosthesis is to be implanted in many cases should be measured accurately and studied carefully, so that a prosthesis such as a crown, denture or bridge, for example, can be properly designed and dimensioned to fit in place. A good fit enables mechanical stresses to be properly transmitted between the prosthesis and the jaw, and to prevent infection of the gums via the interface between the prosthesis and the dental site, for example. Some procedures also call for removable prosthetics to be fabricated to replace one or more missing teeth, such as a partial or full denture, in which case the surface contours of the areas where the teeth are missing need to be reproduced accurately so that the resulting prosthetic fits over the edentulous region with even pressure on the soft tissues.

In some practices, the dental site is prepared by a dental practitioner, and a positive physical model of the dental site is constructed using known methods. Alternatively, the dental site may be scanned to provide 3D data of the dental site. In either case, the virtual or real model of the dental site is sent to the dental lab, which manufactures the prosthesis based on the model. However, if the model is deficient or undefined in certain areas, or if the preparation was not optimally configured for receiving the prosthesis, the design of the prosthesis may be less than optimal. For example, if the insertion path implied by the preparation for a closely-fitting coping would result in the prosthesis colliding with adjacent teeth, the coping geometry has to be altered to avoid the collision, which may result in the coping design being less optimal. Further, if the area of the preparation containing a finish line lacks definition, it may not be possible to properly determine the finish line and thus the lower edge of the coping may not be properly designed. Indeed, in some circumstances, the model is rejected and the dental practitioner then re-scans the dental site, or reworks the preparation, so that a suitable prosthesis may be produced.

In orthodontic procedures it can be important to provide a model of one or both jaws. Where such orthodontic procedures are designed virtually, a virtual model of the oral cavity is also beneficial. Such a virtual model may be obtained by scanning the oral cavity directly, or by producing a physical model of the dentition, and then scanning the model with a suitable scanner.

Thus, in both prosthodontic and orthodontic procedures, obtaining a 3D model of a dental site in the oral cavity is an initial procedure that is performed. When the 3D model is a virtual model, the more complete and accurate the scans of the dental site are, the higher the quality of the virtual model, and thus the greater the ability to design an optimal prosthesis or orthodontic treatment appliance(s).

A scanner may have multiple projectors and multiple cameras. Each projector may project a pattern of light on a dental site in the field of view of at least one camera. The cameras capture images of the patterns of light on the dental site. A scanner may use at least two cameras that overlap to capture images to generate a 3D model of the dental site. A projector is to illuminate the dental site where the cameras are capturing images. To generate a 3D model of the rearmost molars, two cameras and a projector are located at a tip of the scanner. This causes the scanner to have an increased width which causes inefficient and slow scanner maneuvering. This may also cause conventional scanners to not reach certain portions of a mouth (e.g., rearmost molars, etc.).

The devices, systems, and methods of the present disclosure overcome some or all of these challenges.

An intraoral scanner includes an elongate wand that is used to scan inside a mouth (e.g., scan dental arches) of a patient. The intraoral scanner includes a probe housing disposed at a distal end of the elongate wand. At least a portion of the probe housing is to be inserted into a mouth of a patient for scanning. The probe housing forms an interior volume. One or more of the optical components (e.g., cameras, projectors, lightguide projector, light source, lightguide structure, etc.) are disposed in the interior volume of the probe housing.

In some embodiments, the intraoral scanner includes a lightguide projector that includes a light source disposed in the interior volume and a lightguide structure (e.g., disposed in the interior volume or forming the window of the intraoral scanner, the lightguide structure is substantially transparent). The light source is configured to generate light. In some embodiments, the light source is a semiconductor laser device (e.g., the light is a laser beam). In some embodiments, the light source generates white light illumination. In some embodiments, the light source generates near-infrared illumination. In some embodiments, the light source generates coherent light illumination. Near infrared illumination can be either coherent (e.g., as laser) or coherent (e.g., as LED). In some embodiments, the light source generates multiple wavelengths of light. In some embodiments, the light source generates coherent light illumination (e.g., light waves with the same frequency, wavelength, and phase or have a constant wave difference).

In some embodiments, the lightguide structure is an elongated slab of material that has a refractive index higher than the refractive index of the surrounding material. Light propagates through the lightguide structure (e.g., along an elongated axis of the lightguide structure) by total internal reflection (TIR). If the angle of incidence of light through the material meets a threshold value (e.g., is high enough), the TIR condition is fulfilled and light bounces onward within the lightguide structure (e.g., slab) instead of radiating out of the lightguide structure.

The lightguide structure is configured to receive the light from the light source. In some embodiments, a lens and/or an in-coupler structure are disposed between the light source and the lightguide structure.

In some embodiments, the lightguide structure is a plate of glass (e.g., flat plate of glass, layer of glass). In some embodiments, the lightguide structure is a polymer. In some embodiments, the lightguide structure is transparent to the desired input of light. In some embodiments, the lightguide structure is substantially transparent. The light is to propagate through lightguide structure along an elongated axis of the lightguide structure via internal reflections (e.g., total internal reflections (TIR)).

A portion (e.g., reflecting portion, diffracting portion) of the lightguide projector is configured to cause the light to exit the lightguide structure to illuminate a mouth of a patient. In some embodiments, the reflecting portion is a curved mirror (e.g., reflective coating disposed on the lightguide structure) that focuses the light substantially perpendicularly to the elongated axis of the lightguide structure and focuses the light outside of the lightguide structure. In some embodiments, the reflecting portion is a flat mirror and an additional component (e.g., lens) is located outside the lightguide to focus the light (e.g., prior to in-coupling or after out-coupling). In some embodiments, the reflecting portion is a partially reflecting curved source embedded within the lightguide structure (e.g., the partially reflecting curved surface is configured to cause the light to exit the lightguide structure to illuminate the mouth of the patient). The reflecting portion may be partially reflecting so that a first portion of the light is out-coupled (leaves the lightguide structure at a first location) and a second portion of the light continues propagating within the lightguide structure (e.g., to leave the lightguide structure at a second location). In some embodiments, the diffracting portion is a grating (e.g., the grating is configured to cause the light to exit the lightguide structure to illuminate the mouth of the patient). In some embodiments, the grating may be from about 10 microns by 10 microns up to about tens of millimeters by tens of millimeters.

The devices systems, and methods of the present disclosure have advantages over conventional systems. The intraoral scanner of the present disclosure has a decreased width compared to conventional scanners. This allows the intraoral scanner of the present disclosure to have more efficient and quicker scanner maneuvering than conventional scanners. The intraoral scanner of the present disclosure may more easily reach certain portions of a mouth (e.g., rearmost molars, etc.) where conventional devices may not reach. The intraoral scanner of the present disclosure can estimate a 3D surface with a higher degree of accuracy than conventional systems. This results in less time and processing and more accurately designed dental devices compared to conventional systems. The intraoral scanner of the present disclosure has a smaller thickness than conventional solutions. This allows the intraoral scanner of the present disclosure to more easily scan more portions of the mouth of the patient than conventional solutions. The intraoral scanner of the present disclosure has decreased back reflection (e.g., of projected light into cameras) compared to conventional solutions.

Various embodiments are described herein. These various embodiments may be implemented as stand-alone solutions and/or may be combined. Accordingly, references to an embodiment, one embodiment, or some embodiments may refer to the same embodiment and/or to different embodiments. Some embodiments are discussed herein with reference to intraoral scans and intraoral images. However, embodiments described with reference to intraoral scans also apply to lab scans or model/impression scans. A lab scan or model/impression scan may include one or more images of a dental site or of a model or impression of a dental site, which may or may not include height maps, and which may or may not include intraoral two-dimensional (2D) images (e.g., 2D color images).

In some embodiments, the present disclosure describes intraoral scanners including projectors and cameras. In some embodiments, the projectors and/or cameras of the present disclosure may be part of a system that is not an intraoral scanner.

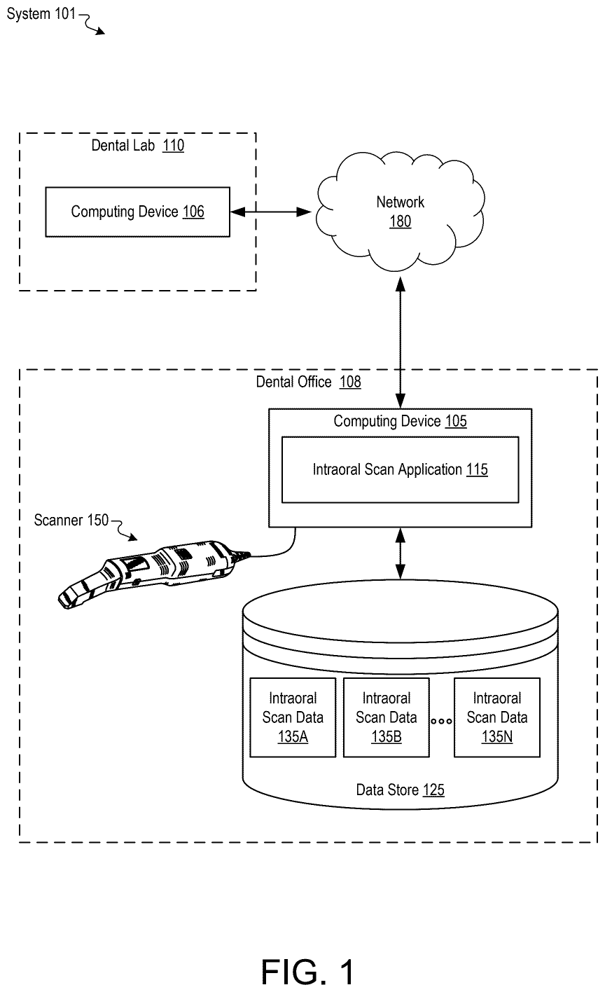

FIG. 1 illustrates a system 101 for performing intraoral scanning and/or generating a 3D surface and/or a virtual 3D model of a dental site, according to certain embodiments. System 101 includes a scanner 150. The scanner 150 may be the intraoral scanner of the present disclosure (e.g., intraoral scanner including a lightguide projector).

System 101 includes a dental office 108 and optionally one or more dental labs 110. The dental office 108 and the dental lab 110 each include a computing device 105, 106, where the computing devices 105, 106 may be connected to one another via a network 180. The network 180 may be a local area network (LAN), a public wide area network (WAN) (e.g., the Internet), a private WAN (e.g., an intranet), or a combination thereof.

Computing device 105 may be coupled to one or more intraoral scanner 150 (also referred to as a scanner) and/or a data store 125 via a wired or wireless connection. In some embodiments, multiple scanners 150 in dental office 108 wirelessly connect to computing device 105. In some embodiments, scanner 150 is wirelessly connected to computing device 105 via a direct wireless connection. In some embodiments, scanner 150 is wirelessly connected to computing device 105 via a wireless network. In some embodiments, the wireless network is a Wi-Fi network. In some embodiments, the wireless network is a Bluetooth network, a Zigbee network, or some other wireless network. In some embodiments, the wireless network is a wireless mesh network, examples of which include a Wi-Fi mesh network, a Zigbee mesh network, and so on. In an example, computing device 105 may be physically connected to one or more wireless access points and/or wireless routers (e.g., Wi-Fi access points/routers). Intraoral scanner 150 may include a wireless module such as a Wi-Fi module, and via the wireless module may join the wireless network via the wireless access point/router.

Computing device 106 may also be connected to a data store (not shown). The data stores may be local data stores and/or remote data stores. Computing device 105 and computing device 106 may each include one or more processing devices, memory, secondary storage, one or more input devices (e.g., such as a keyboard, mouse, tablet, touchscreen, microphone, camera, and so on), one or more output devices (e.g., a display, printer, touchscreen, speakers, etc.), and/or other hardware components.

In some embodiments, scanner 150 includes an inertial measurement unit (IMU). The IMU may include an accelerometer, a gyroscope, a magnetometer, a pressure sensor, and/or other type of sensor. For example, scanner 150 may include one or more micro-electromechanical system (MEMS) IMU. The IMU may generate inertial measurement data (also referred to as movement data), including acceleration data, rotation data, and so on.

Computing device 105 and/or data store 125 may be located at dental office 108 (as shown), at dental lab 110, or at one or more other locations such as a server farm that provides a cloud computing service. Computing device 105 and/or data store 125 may connect to components that are at a same or a different location from computing device 105 (e.g., components at a second location that is remote from the dental office 108, such as a server farm that provides a cloud computing service). For example, computing device 105 may be connected to a remote server, where some operations of intraoral scan application 115 are performed on computing device 105 and some operations of intraoral scan application 115 are performed on the remote server.

Some additional computing devices may be physically connected to the computing device 105 via a wired connection. Some additional computing devices may be wirelessly connected to computing device 105 via a wireless connection, which may be a direct wireless connection or a wireless connection via a wireless network. In embodiments, one or more additional computing devices may be mobile computing devices such as laptops, notebook computers, tablet computers, mobile phones, portable game consoles, and so on. In embodiments, one or more additional computing devices may be traditionally stationary computing devices, such as desktop computers, set top boxes, game consoles, and so on. The additional computing devices may act as thin clients to the computing device 105. In some embodiments, the additional computing devices access computing device 105 using remote desktop protocol (RDP). In some embodiments, the additional computing devices access computing device 105 using virtual network control (VNC). Some additional computing devices may be passive clients that do not have control over computing device 105 and that receive a visualization of a user interface of intraoral scan application 115. In some embodiments, one or more additional computing devices may operate in a master mode and computing device 105 may operate in a slave mode.

Intraoral scanner 150 may include a probe (e.g., a handheld probe) for optically capturing 3D structures. The intraoral scanner 150 may be used to perform an intraoral scan of a patient's oral cavity. An intraoral scan application 115 running on computing device 105 may communicate with the scanner 150 to effectuate the intraoral scan. A result of the intraoral scan may be intraoral scan data 135A, 135B through 135N that may include one or more sets of intraoral scans and/or sets of intraoral 2D images. Each intraoral scan may include a 3D image or point cloud that may include depth information (e.g., a height map) of a portion of a dental site. In embodiments, intraoral scans include x, y, and z information.

Intraoral scan data 135A-N may also include color 2D images and/or images of wavelengths (e.g., near-infrared (NIRI) images, infrared images, ultraviolet images, etc.) of a dental site in embodiments. In embodiments, intraoral scanner 150 alternates between generation of 3D intraoral scans and one or more types of 2D intraoral images (e.g., color images, NIRI images, etc.) during scanning. For example, one or more 2D color images may be generated between generation of a fourth and fifth intraoral scan by outputting white light and capturing reflections of the white light using multiple cameras.

Intraoral scanner 150 may include multiple different cameras (e.g., each of which may include one or more image sensors) that generate 2D images (e.g., 2D color images) of different regions of a patient's dental arch concurrently. These 2D images may be stitched together to form a single 2D image representation of a larger field of view that includes a combination of the fields of view of the multiple cameras. Intraoral 2D images may include 2D color images, 2D infrared or near-infrared (NIRI) images, and/or 2D images generated under other specific lighting conditions (e.g., 2D ultraviolet images). The 2D images may be used by a user of the intraoral scanner to determine where the scanning face of the intraoral scanner is directed and/or to determine other information about a dental site being scanned.

The scanner 150 may transmit the intraoral scan data 135A, 135B through 135N to the computing device 105. Computing device 105 may store the intraoral scan data 135A-135N in data store 125.

According to an example, a user (e.g., a practitioner) may subject a patient to intraoral scanning. In doing so, the user may apply scanner 150 to one or more patient intraoral locations. The scanning may be divided into one or more segments (also referred to as roles). As an example, the segments may include a lower dental arch of the patient, an upper dental arch of the patient, one or more preparation teeth of the patient (e.g., teeth of the patient to which a dental device such as a crown or other dental prosthetic will be applied), one or more teeth which are contacts of preparation teeth (e.g., teeth not themselves subject to a dental device but which are located next to one or more such teeth or which interface with one or more such teeth upon mouth closure), and/or patient bite (e.g., scanning performed with closure of the patient's mouth with the scan being directed towards an interface area of the patient's upper and lower teeth). Via such scanner application, the scanner 150 may provide intraoral scan data 135A-N to computing device 105. The intraoral scan data 135A-N may be provided in the form of intraoral scan data sets, each of which may include 2D intraoral images (e.g., color 2D images) and/or 3D intraoral scans of particular teeth and/or regions of a dental site. In some embodiments, separate intraoral scan data sets are created for the maxillary arch, for the mandibular arch, for a patient bite, and/or for each preparation tooth. Alternatively, a single large intraoral scan data set is generated (e.g., for a mandibular and/or maxillary arch). Intraoral scans may be provided from the scanner 150 to the computing device 105 in the form of one or more points (e.g., one or more pixels and/or groups of pixels). For instance, the scanner 150 may provide an intraoral scan as one or more point clouds. The intraoral scans may each include height information (e.g., a height map that indicates a depth for each pixel).

The manner in which the oral cavity of a patient is to be scanned may depend on the procedure to be applied thereto. For example, if an upper or lower denture is to be created, then a full scan of the mandibular or maxillary edentulous arches may be performed. In contrast, if a bridge is to be created, then just a portion of a total arch may be scanned which includes an edentulous region, the neighboring preparation teeth (e.g., abutment teeth) and the opposing arch and dentition. Alternatively, full scans of upper and/or lower dental arches may be performed if a bridge is to be created.

By way of non-limiting example, dental procedures may be broadly divided into prosthodontic (restorative) and orthodontic procedures, and then further subdivided into specific forms of these procedures. Additionally, dental procedures may include identification and treatment of gum disease, sleep apnea, and intraoral conditions. The term prosthodontic procedure refers, inter alia, to any procedure involving the oral cavity and directed to the design, manufacture, or installation of a dental prosthesis at a dental site within the oral cavity (dental site), or a real or virtual model thereof, or directed to the design and preparation of the dental site to receive such a prosthesis. A prosthesis may include any restoration such as crowns, veneers, inlays, onlays, implants and bridges, for example, and any other artificial partial or complete denture. The term orthodontic procedure refers, inter alia, to any procedure involving the oral cavity and directed to the design, manufacture, or installation of orthodontic elements at a dental site within the oral cavity, or a real or virtual model thereof, or directed to the design and preparation of the dental site to receive such orthodontic elements. These elements may be appliances including but not limited to brackets and wires, retainers, clear aligners, or functional appliances.

In embodiments, intraoral scanning may be performed on a patient's oral cavity during a visitation of dental office 108. The intraoral scanning may be performed, for example, as part of a semi-annual or annual dental health checkup. The intraoral scanning may also be performed before, during and/or after one or more dental treatments, such as orthodontic treatment and/or prosthodontic treatment. The intraoral scanning may be a full or partial scan of the upper and/or lower dental arches and may be performed to gather information for performing dental diagnostics, to generate a treatment plan, to determine progress of a treatment plan, and/or for other purposes. The dental information (intraoral scan data 135A-N) generated from the intraoral scanning may include 3D scan data, 2D color images, NIRI and/or infrared images, and/or ultraviolet images, of all or a portion of the upper jaw and/or lower jaw. The intraoral scan data 135A-N may further include one or more intraoral scans showing a relationship of the upper dental arch to the lower dental arch. These intraoral scans may be usable to determine a patient bite and/or to determine occlusal contact information for the patient. The patient bite may include determined relationships between teeth in the upper dental arch and teeth in the lower dental arch.

For many prosthodontic procedures (e.g., to create a crown, bridge, veneer, etc.), an existing tooth of a patient is ground down to a stump. The ground tooth is referred to herein as a preparation tooth, or simply a preparation. The preparation tooth has a margin line (also referred to as a finish line), which is a border between a natural (unground) portion of the preparation tooth and the prepared (ground) portion of the preparation tooth. The preparation tooth is typically created so that a crown or other prosthesis can be mounted or seated on the preparation tooth. In many instances, the margin line of the preparation tooth is sub-gingival (below the gum line).

Intraoral scanners may work by moving the scanner 150 inside a patient's mouth to capture all viewpoints of one or more tooth. During scanning, the scanner 150 is calculating distances to solid surfaces in some embodiments. These distances may be recorded as images called ‘height maps’ or as point clouds in some embodiments. Each scan (e.g., optionally height map or point cloud) is overlapped algorithmically, or ‘stitched,’ with the previous set of scans to generate a growing 3D surface. As such, each scan is associated with a rotation in space, or a projection, to how it fits into the 3D surface.

During intraoral scanning, intraoral scan application 115 may register and stitch together two or more intraoral scans generated thus far from the intraoral scan session to generate a growing 3D surface. In some embodiments, performing registration includes capturing 3D data of various points of a surface in multiple scans, and registering the scans by computing transformations between the scans. One or more 3D surfaces may be generated based on the registered and stitched together intraoral scans during the intraoral scanning. The one or more 3D surfaces may be output to a display so that a doctor or technician can view their scan progress thus far. As each new intraoral scan is captured and registered to previous intraoral scans and/or a 3D surface, the one or more 3D surfaces may be updated, and the updated 3D surface(s) may be output to the display. A view of the 3D surface(s) may be periodically or continuously updated according to one or more viewing modes of the intraoral scan application. In one viewing mode, the 3D surface may be continuously updated such that an orientation of the 3D surface that is displayed aligns with a field of view of the intraoral scanner (e.g., so that a portion of the 3D surface that is based on a most recently generated intraoral scan is approximately centered on the display or on a window of the display) and a user sees what the intraoral scanner sees. In one viewing mode, a position and orientation of the 3D surface is static, and an image of the intraoral scanner is optionally shown to move relative to the stationary 3D surface.

Intraoral scan application 115 may generate one or more 3D surfaces from intraoral scans and may display the 3D surfaces to a user (e.g., a doctor) via a graphical user interface (GUI) during intraoral scanning. In embodiments, separate 3D surfaces are generated for the upper jaw and the lower jaw. This process may be performed in real time or near-real time to provide an updated view of the captured 3D surfaces during the intraoral scanning process. As scans are received, these scans may be registered and stitched to a 3D surface. Quality scores may be determined for various regions of the 3D surface based on one or more criteria as discussed in detail below. The quality scores may be continuously or periodically updated as information is added from further intraoral scans. As the quality scores gradually change, a visualization of the regions may change in accordance with the changes in the quality scores, enabling a user to have real time or near real time feedback on surface quality during scanning. Additionally, or alternatively, as scans are received the scanning process may be monitored to determine if a user is having trouble scanning any regions of a dental site (e.g., of the upper or lower dental arch). If a determination is made that a user is having trouble scanning a region of the dental site, then one or more remedial actions may be performed and/or one or more suggestions may be provided. Additionally, or alternatively, as scanning is being performed a zoom setting for displaying the 3D surface(s) may be dynamically determined based on one or more criteria, such as a velocity of the scanner and/or of a point of focus of the scanner. In embodiments, a user may select to enable or disable automatic zoom and/or automatic suggestions via the GUI. For example, the user may input a request for scanning assistance, which may cause automatic zoom and/or scanning suggestions to be enabled. These and other operations may be performed during scanning to improve a quality of the 3D surface(s), to speed up scanning, to help a user in trouble areas, and so on.

When a scan session or a portion of a scan session associated with a particular scanning role (e.g., upper jaw role, lower jaw role, bite role, etc.) is complete (e.g., all scans for an dental site or dental site have been captured), intraoral scan application 115 may generate a virtual 3D model of one or more scanned dental sites (e.g., of an upper jaw and a lower jaw). The final 3D model may be a set of 3D points and their connections with each other (i.e., a mesh). To generate the virtual 3D model, intraoral scan application 115 may register and stitch together the intraoral scans generated from the intraoral scan session that are associated with a particular scanning role. The registration performed at this stage may be more accurate than the registration performed during the capturing of the intraoral scans and may take more time to complete than the registration performed during the capturing of the intraoral scans. In some embodiments, performing scan registration includes capturing 3D data of various points of a surface in multiple scans, and registering the scans by computing transformations between the scans. The 3D data may be projected into a 3D space of a 3D model to form a portion of the 3D model. The intraoral scans may be integrated into a common reference frame by applying appropriate transformations to points of each registered scan and projecting each scan into the 3D space.

In some embodiments, registration is performed for adjacent or overlapping intraoral scans (e.g., each successive frame of an intraoral video). Registration algorithms are carried out to register two adjacent or overlapping intraoral scans and/or to register an intraoral scan with a 3D model, which essentially involves determination of the transformations which align one scan with the other scan and/or with the 3D model. Registration may involve identifying multiple points in each scan (e.g., point clouds) of a scan pair (or of a scan and the 3D model), surface fitting to the points, and using local searches around points to match points of the two scans (or of the scan and the 3D model). For example, intraoral scan application 115 may match points of one scan with the closest points interpolated on the surface of another scan, and iteratively minimize the distance between matched points. Other registration techniques may also be used.

Intraoral scan application 115 may repeat registration for all intraoral scans of a sequence of intraoral scans to obtain transformations for each intraoral scan, to register each intraoral scan with previous intraoral scan(s) and/or with a common reference frame (e.g., with the 3D model). Intraoral scan application 115 may integrate intraoral scans into a single virtual 3D model by applying the appropriate determined transformations to each of the intraoral scans. Each transformation may include rotations about one to three axes and translations within one to three planes.

Intraoral scan application 115 may generate one or more 3D models from intraoral scans and may display the 3D models to a user (e.g., a doctor) via a graphical user interface (GUI). The 3D models can then be checked visually by the doctor. The doctor can virtually manipulate the 3D models via the user interface with respect to up to six degrees of freedom (i.e., translated and/or rotated with respect to one or more of three mutually orthogonal axes) using suitable user controls (hardware and/or virtual) to enable viewing of the 3D model from any desired direction.

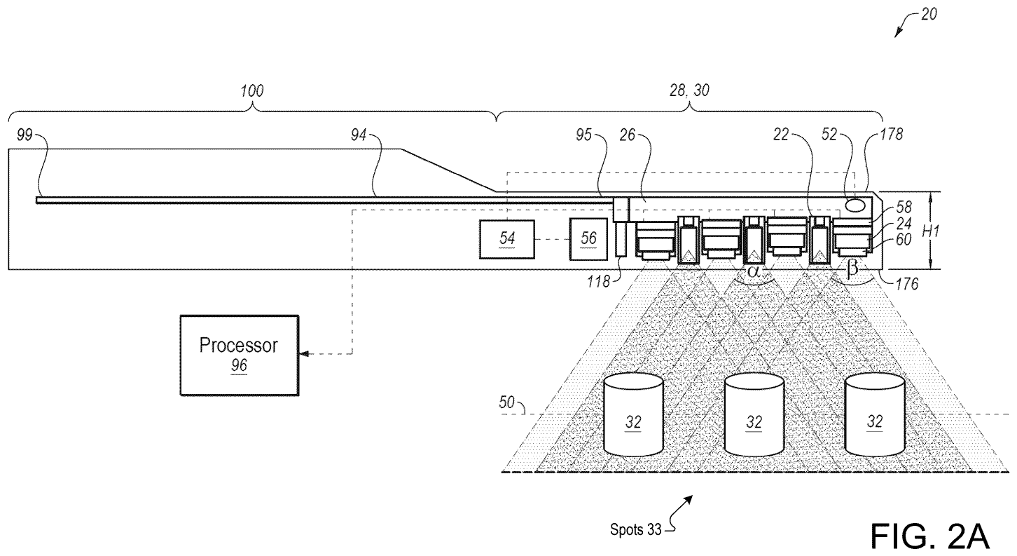

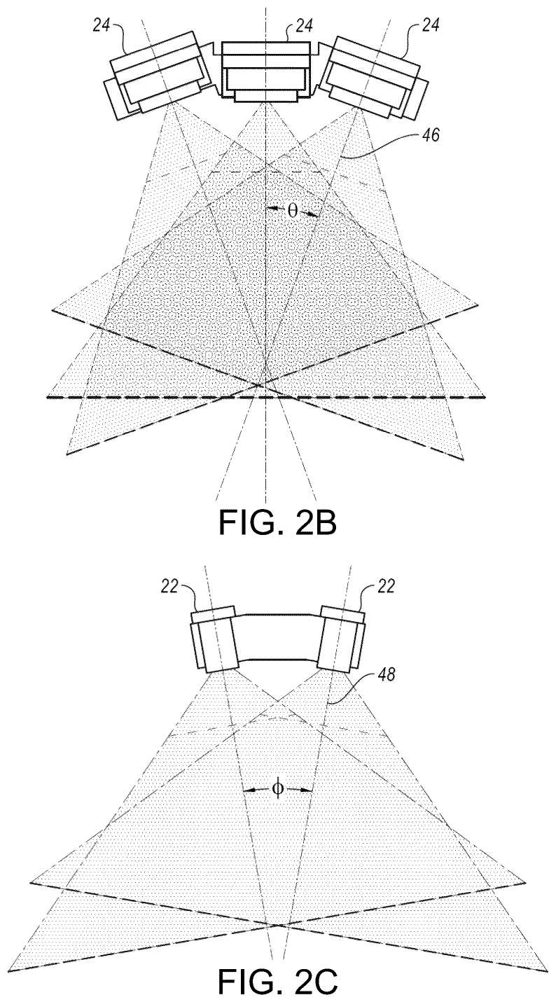

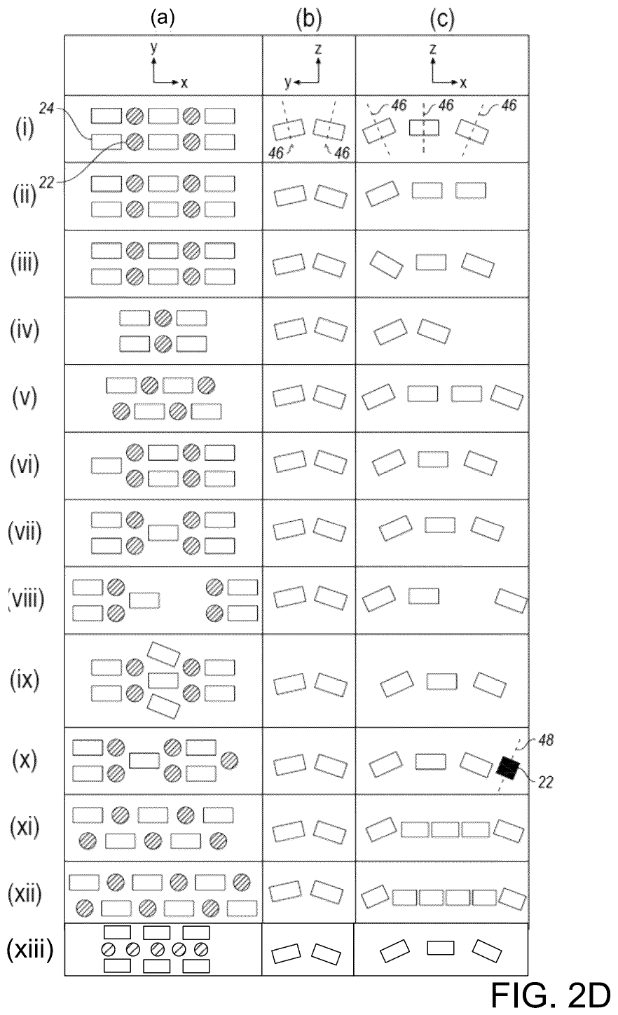

Reference is now made to FIG. 2A, which is a schematic illustration of an intraoral scanner 20 including an elongate handheld wand, according to certain embodiments. The intraoral scanner 20 may correspond to intraoral scanner 150 of FIG. 1 in some embodiments. Intraoral scanner 20 may be the intraoral scanner of the present disclosure (e.g., intraoral scanner including a lightguide projector).

Intraoral scanner 20 includes a plurality of structured light projectors 22 (e.g., projectors) and a plurality of cameras 24 that are coupled to a rigid structure 26 disposed within a probe 28 at a distal end 30 of the intraoral scanner 20. In some applications, during an intraoral scanning procedure, probe 28 is inserted into the oral cavity of a subject or patient.

For some applications, structured light projectors 22 are positioned within probe 28 such that each structured light projector 22 faces an object 32 outside of intraoral scanner 20 that is placed in its field of illumination, as opposed to positioning the structured light projectors in a proximal end of the handheld wand and illuminating the object by reflection of light off a mirror and subsequently onto the object. Alternatively, the structured light projectors may be disposed at a proximal end of the handheld wand. Similarly, for some applications, cameras 24 are positioned within probe 28 such that each camera 24 faces an object 32 outside of intraoral scanner 20 that is placed in its field of view, as opposed to positioning the cameras in a proximal end of the intraoral scanner and viewing the object by reflection of light off a mirror and into the camera. This positioning of the projectors and the cameras within probe 28 enables the scanner to have an overall large field of view while maintaining a low-profile probe. Alternatively, the cameras may be disposed in a proximal end of the handheld wand.

In some applications, cameras 24 each have a large field of view β (beta) of at least 45 degrees, e.g., at least 70 degrees, e.g., at least 80 degrees, e.g., 85 degrees. In some applications, the field of view may be less than 120 degrees, e.g., less than 100 degrees, e.g., less than 90 degrees. In some embodiments, a field of view β (beta) for each camera is between 80 and 90 degrees, which may be particularly useful because it provided a good balance among pixel size, field of view and camera overlap, optical quality, and cost. Cameras 24 may include an image sensor 58 and objective optics 60 including one or more lenses. To enable close focus imaging, cameras 24 may focus on an object focal plane 50 that is located between 1 mm and 30 mm, e.g., between 4 mm and 24 mm, e.g., between 5 mm and 11 mm, e.g., 9 mm-10 mm, from the lens that is farthest from the sensor. In some applications, cameras 24 may capture images at a frame rate of at least 30 frames per second, e.g., at a frame of at least 75 frames per second, e.g., at least 100 frames per second. In some applications, the frame rate may be less than 200 frames per second.

A large field of view achieved by combining the respective fields of view of all the cameras may improve accuracy due to reduced amount of image stitching errors, especially in edentulous regions, where the gum surface is smooth and there may be fewer clear high resolution 3D features. Having a larger field of view enables large smooth features, such as the overall curve of the tooth, to appear in each image frame, which improves the accuracy of stitching respective surfaces obtained from multiple such image frames.

Similarly, in some embodiments, structured light projectors 22 may each have a large field of illumination a (alpha) of at least 45 degrees, e.g., at least 70 degrees. In some applications, field of illumination a (alpha) may be less than 120 degrees, e.g., than 100 degrees. In some embodiments, the lightguide projectors 22 may introduce an angular field of view (e.g., a very small angular FOV) where all spots projected are substantially parallel to each other over a predetermined distance (e.g., from the lightguide projector 22 to the mount of the patient).

For some applications, to improve image capture, each camera 24 has a plurality of discrete preset focus positions, in each focus position the camera focusing on a respective object focal plane 50. Each of cameras 24 may include an autofocus actuator that selects a focus position from the discrete preset focus positions to improve a given image capture. In some embodiments, the lightguide projector 22 may have out-couplers (e.g., focusing grating couplers) that are each configured for a different focus distance. Additionally or alternatively, each camera 24 includes an optical aperture phase mask that extends a depth of focus of the camera, such that images formed by each camera are maintained focused over all object distances located between 1 mm and 30 mm, e.g., between 4 mm and 24 mm, e.g., between 5 mm and 11 mm, e.g., 9 mm-10 mm, from the lens surface that is farthest from the sensor.

In some applications, structured light projectors 22 and cameras 24 are coupled to rigid structure 26 in a closely packed and/or alternating fashion, such that (a) a substantial part of each camera's field of view overlaps the field of view of neighboring cameras, and (b) a substantial part of each camera's field of view overlaps the field of illumination of neighboring projectors. Optionally, at least 20%, e.g., at least 50%, e.g., at least 75% of the projected pattern of light are in the field of view of at least one of the cameras at an object focal plane 50 that is located at least 4 mm from the lens that is farthest from the sensor. Due to different possible configurations of the projectors and cameras, some of the projected pattern may never be seen in the field of view of any of the cameras, and some of the projected pattern may be blocked from view by object 32 as the scanner is moved around during a scan.

Rigid structure 26 may be a non-flexible structure to which structured light projectors 22 and cameras 24 are coupled so as to provide structural stability to the optics within probe 28. Coupling all the projectors and all the cameras to a common rigid structure helps maintain geometric integrity of the optics of each structured light projector 22 and each camera 24 under varying ambient conditions, e.g., under mechanical stress as may be induced by the subject's mouth. Additionally, rigid structure 26 helps maintain stable structural integrity and positioning of structured light projectors 22 and cameras 24 with respect to each other.

Reference is now made to FIGS. 2B-2C, which include schematic illustrations of a positioning configuration for cameras 24 and structured light projectors 22 respectively, according to certain embodiments. The cameras 24 and/or structured light projectors 22 may be of the intraoral scanner of the present disclosure (e.g., intraoral scanner including a lightguide projector).

For some applications, to improve the overall field of view and field of illumination of the intraoral scanner 20, cameras 24 and structured light projectors 22 are positioned such that they do not all face the same direction. For some applications, such as is shown in FIG. 2B, a plurality of cameras 24 are coupled to rigid structure 26 such that an angle θ (theta) between two respective optical axes 46 of at least two cameras 24 is 90 degrees or less, e.g., 35 degrees or less. Similarly, for some applications, such as is shown in FIG. 2C, a plurality of structured light projectors 22 are coupled to rigid structure 26 such that an angle q (phi) between two respective optical axes 48 of at least two structured light projectors 22 is 90 degrees or less, e.g., 35 degrees or less.

Reference is now made to FIG. 2D, which is a chart depicting a plurality of different configurations for the position of structured light projectors 22 and cameras 24 in probe 28, according to certain embodiments. The cameras 24 and/or structured light projectors 22 may be of the intraoral scanner of the present disclosure (e.g., intraoral scanner including a lightguide projector).

Structured light projectors 22 are represented in FIG. 2D by circles and cameras 24 are represented in FIG. 2D by rectangles. It is noted that rectangles are used to represent the cameras, since typically, each image sensor 58 and the field of view B (beta) of each camera 24 have aspect ratios of 1:2. Column (a) of FIG. 2D shows a bird's eye view of the various configurations of structured light projectors 22 and cameras 24. The x-axis as labeled in the first row of column (a) corresponds to a central longitudinal axis of probe 28. Column (b) shows a side view of cameras 24 from the various configurations as viewed from a line of sight that is coaxial with the central longitudinal axis of probe 28 and substantially parallel to a viewing axis of the intraoral scanner. Similar to as shown in FIG. 2B, column (b) of FIG. 2D shows cameras 24 positioned so as to have optical axes 46 at an angle of 90 degrees or less, e.g., 35 degrees or less, with respect to each other. Column (c) shows a side view of cameras 24 of the various configurations as viewed from a line of sight that is perpendicular to the central longitudinal axis of probe 28.

Typically, the distal-most (toward the positive x-direction in FIG. 2D) and proximal-most (toward the negative x-direction in FIG. 2D) cameras 24 are positioned such that their optical axes 46 are slightly turned inwards, e.g., at an angle of 90 degrees or less, e.g., 35 degrees or less, with respect to the next closest camera 24. The camera(s) 24 that are more centrally positioned, i.e., not the distal-most camera 24 nor proximal-most camera 24, are positioned so as to face directly out of the probe, their optical axes 46 being substantially perpendicular to the central longitudinal axis of probe 28. It is noted that in row (xi) a projector 22 is positioned in the distal-most position of probe 28, and as such the optical axis 48 of that projector 22 points inwards, allowing a larger number of spots 33 projected from that particular projector 22 to be seen by more cameras 24.

In embodiments, the number of structured light projectors 22 in probe 28 may range from two, e.g., as shown in row (iv) of FIG. 2D, to six, e.g., as shown in row (xii). Typically, the number of cameras 24 in probe 28 may range from four, e.g., as shown in rows (iv) and (v), to seven, e.g., as shown in row (ix). It is noted that the various configurations shown in FIG. 2D are by way of example and not limitation, and that the scope of the present disclosure includes additional configurations not shown. For example, the scope of the present disclosure includes fewer or more than five projectors 22 positioned in probe 28 and fewer or more than seven cameras positioned in probe 28.

In an example application, an apparatus for intraoral scanning (e.g., an intraoral scanner 150) includes an elongate handheld wand including a probe at a distal end of the elongate handheld wand, at least two light projectors (e.g., or one or more lightguide projectors) disposed within the probe, and at least four cameras disposed within the probe. Each light projector may include at least one light source configured to generate light when activated, and a pattern generating optical element that is configured to generate a pattern of light when the light is transmitted through the pattern generating optical element. Each of the at least four cameras may include a camera sensor (also referred to as an image sensor) and one or more lenses, wherein each of the at least four cameras is configured to capture a plurality of images that depict at least a portion of the projected pattern of light on an intraoral surface. A majority of the at least two light projectors and the at least four cameras may be arranged in at least two rows that are each approximately parallel to a longitudinal axis of the probe, the at least two rows including at least a first row and a second row.

In a further application, a distal-most camera along the longitudinal axis and a proximal-most camera along the longitudinal axis of the at least four cameras are positioned such that their optical axes are at an angle of 90 degrees or less with respect to each other from a line of sight that is perpendicular to the longitudinal axis. Cameras in the first row and cameras in the second row may be positioned such that optical axes of the cameras in the first row are at an angle of 90 degrees or less with respect to optical axes of the cameras in the second row from a line of sight that is coaxial with the longitudinal axis of the probe. A remainder of the at least four cameras other than the distal-most camera and the proximal-most camera have optical axes that are substantially parallel to the longitudinal axis of the probe. Each of the at least two rows may include an alternating sequence of light projectors and cameras.

In a further application, the at least four cameras include at least five cameras, the at least two light projectors include at least five light projectors, a proximal-most component in the first row is a light projector, and a proximal-most component in the second row is a camera.

In a further application, the distal-most camera along the longitudinal axis and the proximal-most camera along the longitudinal axis are positioned such that their optical axes are at an angle of 35 degrees or less with respect to each other from the line of sight that is perpendicular to the longitudinal axis. The cameras in the first row and the cameras in the second row may be positioned such that the optical axes of the cameras in the first row are at an angle of 35 degrees or less with respect to the optical axes of the cameras in the second row from the line of sight that is coaxial with the longitudinal axis of the probe.

In a further application, the at least four cameras may have a combined field of view of 25-45 mm along the longitudinal axis and a field of view of 20-40 mm along a z-axis corresponding to distance from the probe.

Returning to FIG. 2A, for some applications, there is at least one uniform light projector 118 (which may be an unstructured light projector that projects light across a range of wavelengths) coupled to rigid structure 26. Uniform light projector 118 may transmit white light onto object 32 being scanned. At least one camera, e.g., one of cameras 24, captures 2D color images of object 32 using illumination from uniform light projector 118.

Processor 96 may run a surface reconstruction algorithm that may use detected patterns (e.g., dot patterns) projected onto object 32 to generate a 3D surface of the object 32. In some embodiments, the processor 96 may combine at least one 3D scan captured using illumination from structured light projectors 22 with a plurality of intraoral 2D images captured using illumination from uniform light projector 118 in order to generate a digital 3D image of the intraoral 3D surface. Using a combination of structured light and uniform illumination enhances the overall capture of the intraoral scanner and may help reduce the number of options that processor 96 needs to consider when running a correspondence algorithm used to detect depth values for object 32. In some embodiments, the intraoral scanner and correspondence algorithm described in U.S. application Ser. No. 16/446,181, filed Jun. 19, 2019, is used. U.S. application Ser. No. 16/446,181, filed Jun. 19, 2019, is incorporated by reference herein in its entirety. In embodiments, processor 96 may be a processor of computing device 105 of FIG. 1. Alternatively, processor 96 may be a processor integrated into the intraoral scanner 20.

For some applications, all data points taken at a specific time are used as a rigid point cloud, and multiple such point clouds are captured at a frame rate of over 10 captures per second. The plurality of point clouds is then stitched together using a registration algorithm, e.g., iterative closest point (ICP), to create a dense point cloud. A surface reconstruction algorithm may then be used to generate a representation of the surface of object 32.

For some applications, at least one temperature sensor 52 is coupled to rigid structure 26 and measures a temperature of rigid structure 26. Temperature control circuitry 54 disposed within intraoral scanner 20 (a) receives data from temperature sensor 52 indicative of the temperature of rigid structure 26 and (b) activates a temperature control unit 56 in response to the received data. Temperature control unit 56, e.g., a PID controller, keeps probe 28 at a desired temperature (e.g., between 35 and 43 degrees Celsius, between 37 and 41 degrees Celsius, etc.). Keeping probe 28 above 35 degrees Celsius, e.g., above 37 degrees Celsius, reduces fogging of the glass surface of intraoral scanner 20, through which structured light projectors 22 project and cameras 24 view, as probe 28 enters the intraoral cavity, which is typically around or above 37 degrees Celsius. Keeping probe 28 below 43 degrees, e.g., below 41 degrees Celsius, prevents discomfort or pain.

In some embodiments, heat may be drawn out of the probe 28 via a heat conducting element 94, e.g., a heat pipe, that is disposed within intraoral scanner 20, such that a distal end 95 of heat conducting element 94 is in contact with rigid structure 26 and a proximal end 99 is in contact with a proximal end 100 of intraoral scanner 20. Heat is thereby transferred from rigid structure 26 to proximal end 100 of intraoral scanner 20. Alternatively, or additionally, a fan disposed in a handle region 174 of intraoral scanner 20 may be used to draw heat out of probe 28.

FIGS. 2A-2D illustrate one type of intraoral scanner that can be used for embodiments of the present disclosure. However, embodiments are not limited to the illustrated type of intraoral scanner. In some embodiments, intraoral scanner 150 corresponds to the intraoral scanner described in U.S. application Ser. No. 16/910,042, filed Jun. 23, 2020 and entitled “Intraoral 3D Scanner Employing Multiple Miniature Cameras and Multiple Miniature Pattern Projectors”, which is incorporated by reference herein. In some embodiments, intraoral scanner 150 corresponds to the intraoral scanner described in U.S. application Ser. No. 16/446,181, filed Jun. 19, 2019 and entitled “Intraoral 3D Scanner Employing Multiple Miniature Cameras and Multiple Miniature Pattern Projectors”, which is incorporated by reference herein.

In some embodiments an intraoral scanner that performs confocal focusing to determine depth information may be used. Such an intraoral scanner may include a light source and/or illumination module that emits light (e.g., a focused light beam or array of focused light beams). The light passes through a polarizer and through a unidirectional mirror or beam splitter (e.g., a polarizing beam splitter) that passes the light. The light may pass through a pattern before or after the beam splitter to cause the light to become patterned light. Along an optical path of the light after the unidirectional mirror or beam splitter are optics, which may include one or more lens groups. Any of the lens groups may include only a single lens or multiple lenses. One of the lens groups may include at least one moving lens.

The light may pass through an endoscopic probing member, which may include a rigid, light-transmitting medium, which may be a hollow object defining within it a light transmission path or an object made of a light transmitting material, e.g., a glass body or tube. In some embodiments, the endoscopic probing member includes a prism such as a folding prism. At its end, the endoscopic probing member may include a mirror of the kind ensuring a total internal reflection. Thus, the mirror may direct the array of light beams towards a teeth segment or other object. The endoscope probing member thus emits light, which optionally passes through one or more windows and then impinges on to surfaces of intraoral objects.

The light may include an array of light beams arranged in an X-Y plane, in a Cartesian frame, propagating along a Z axis, which corresponds to an imaging axis or viewing axis of the intraoral scanner. Responsive to the surface on which the incident light beams hits being an uneven surface, illuminated spots may be displaced from one another along the Z axis, at different (Xᵢ, Yᵢ) locations. Thus, while a spot at one location may be in focus of the confocal focusing optics, spots at other locations may be out-of-focus. Therefore, the light intensity of returned light beams of the focused spots will be at its peak, while the light intensity at other spots will be off peak.

Thus, for each illuminated spot, multiple measurements of light intensity are made at different positions along the Z-axis. For each of such (Xᵢ, Yᵢ) location, the derivative of the intensity over distance (Z) may be made, with the Zᵢ yielding maximum derivative, Z₀, being the in-focus distance.

The light reflects off intraoral objects and passes back through windows (if they are present), reflects off of the mirror, passes through the optical system, and is reflected by the beam splitter onto a detector. The detector is an image sensor having a matrix of sensing elements each representing a pixel of the scan or image. In some embodiments, the detector is a charge coupled device (CCD) sensor. In some embodiments, the detector is a complementary metal-oxide semiconductor (CMOS) type image sensor. Other types of image sensors may also be used for detector. In some embodiments, the detector detects light intensity at each pixel, which may be used to compute height or depth.

Alternatively, in some embodiments an intraoral scanner that uses stereo imaging is used to determine depth information.

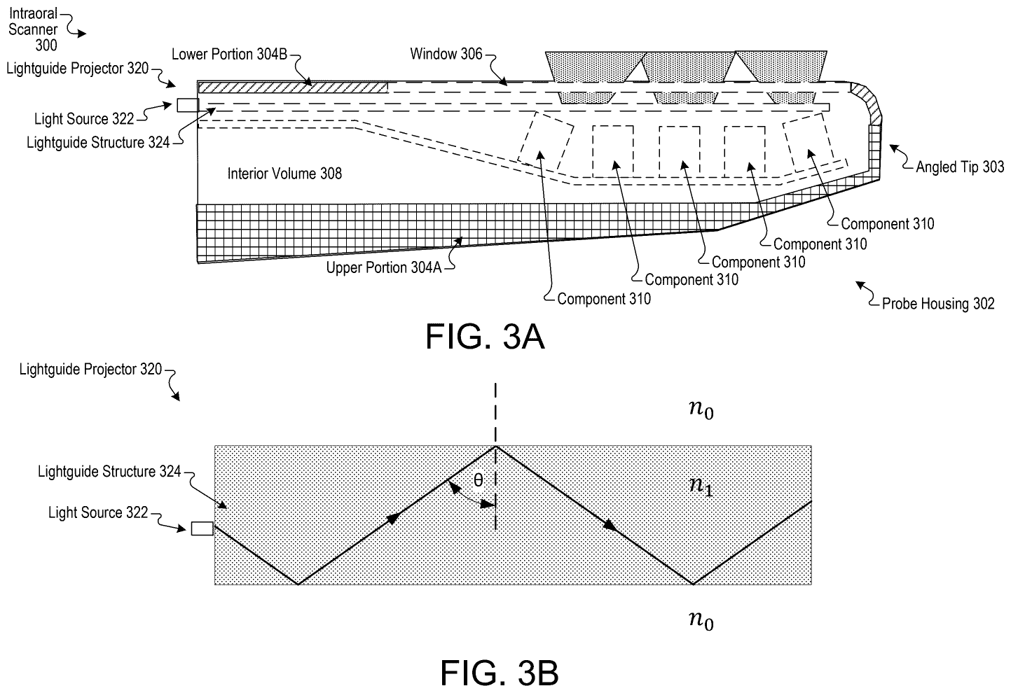

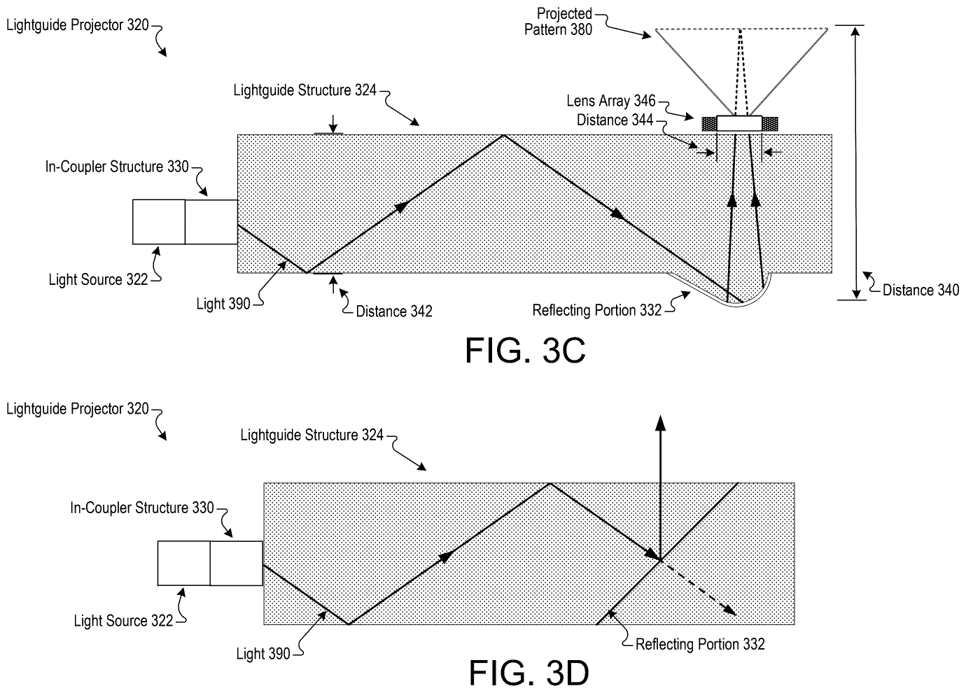

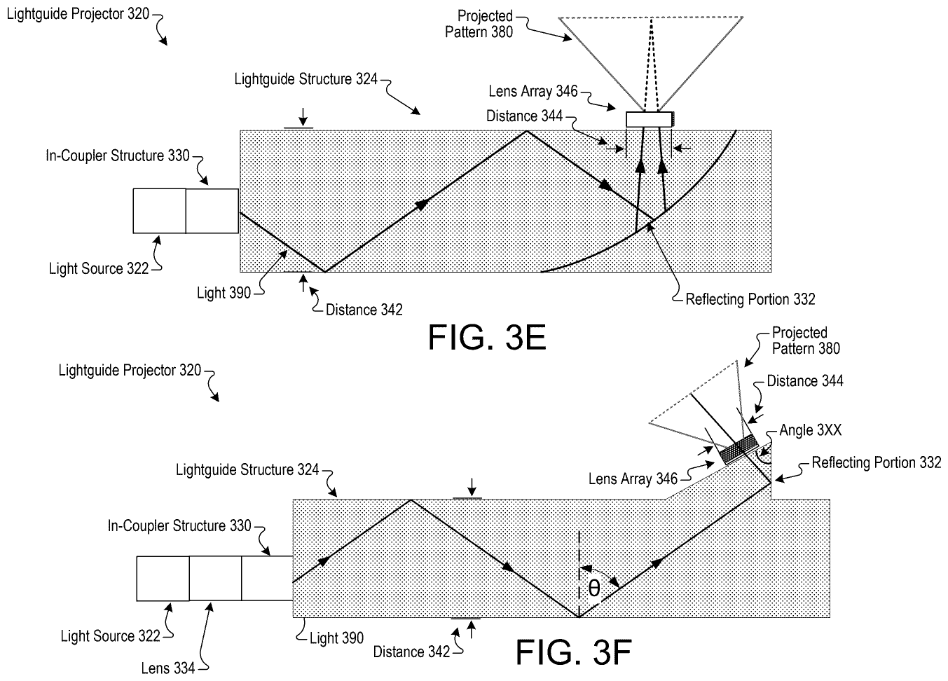

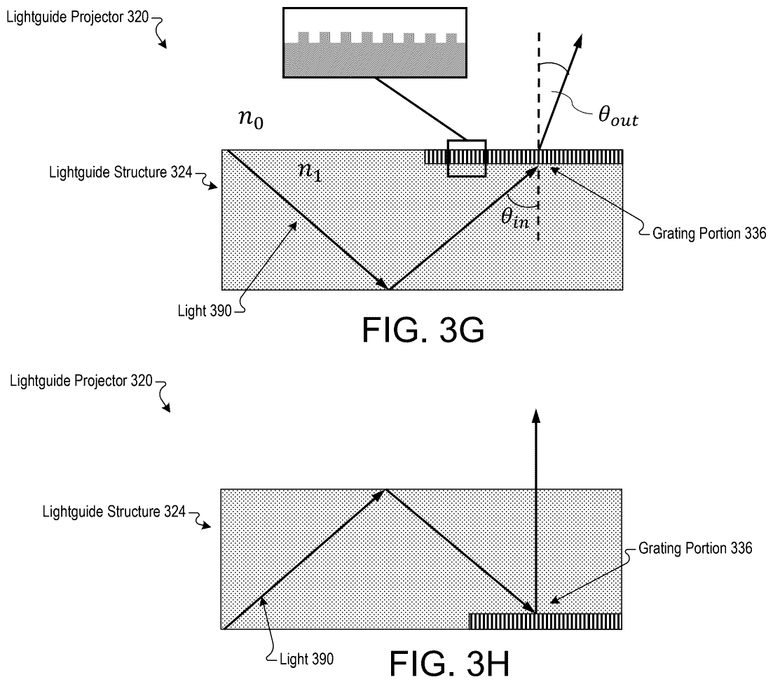

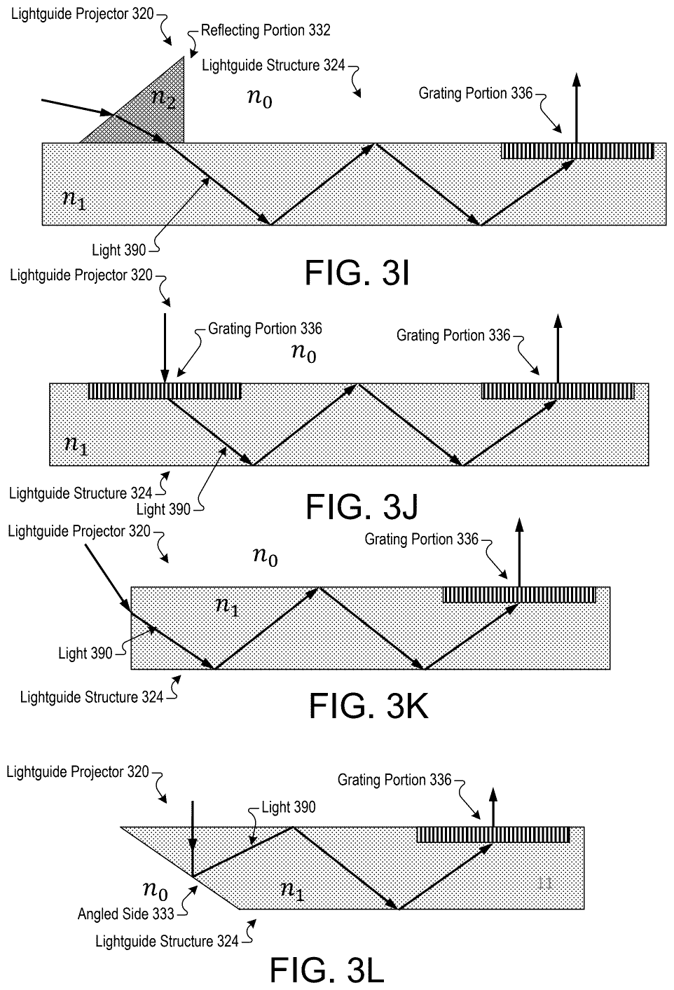

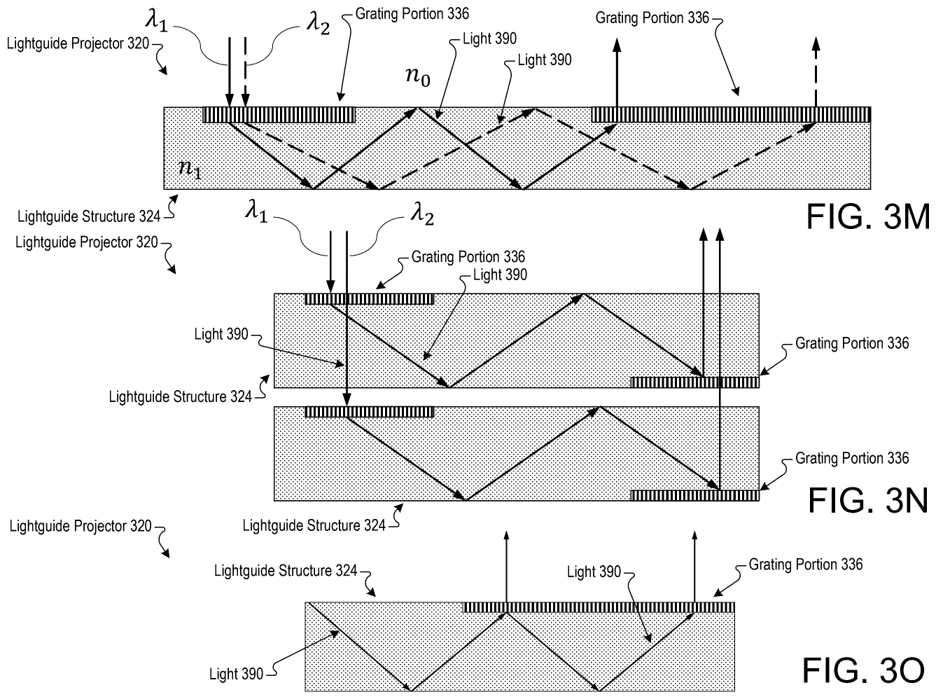

FIGS. 3A-O illustrate side views of components of intraoral scanners 300 (e.g., that have a lightguide projector), according to certain embodiments. In some embodiments, intraoral scanners 300 of one or more of FIGS. 3A-F include similar or the same functionality, components, materials, and/or the like as one or more of scanner 150 of FIG. 1 and/or intraoral scanner 20 of FIGS. 2A-D.

FIG. 3A illustrates a cross-sectional side view of components of an intraoral scanner 300 (e.g., that has a lightguide projector), according to certain embodiments. Intraoral scanner 300 may include a probe housing 302 (e.g., thin stainless-steel enclosure) disposed at a distal end of an elongate wand. The probe housing 302 may include an upper portion 304A and a lower portion 304B.

In some embodiments, the intraoral scanner 300 further includes a window 306 (e.g., window structure) coupled to the probe housing 302. In some embodiments, the window 306 (e.g., window structure) is coupled to the probe housing 302. The window 306 may be disposed in the lower portion 304B. In some embodiments, the lightguide structure 324 is used as a window 306 (e.g., there is no additional window 306 in addition to the lightguide structure 324). In some embodiments, the lightguide structure 324 is substantially transparent.

The probe housing 302 may form an interior volume 308. The intraoral scanner 300 may include optical components at least partially disposed in the interior volume 308. The optical components may include components 310 (e.g., cameras, projectors, etc.) and a lightguide projector 320.

The intraoral scanner 300 may be a wand that is connected to a computation station. The tip of the intraoral scanner 300 may be inserted into the oral cavity of a person while scanning procedure is performed. A disposable sleeve may be placed over the tip of the intraoral scanner 300 prior to being inserted in the oral cavity. The tip of the intraoral scanner 300 may be part of an assembly that is separate from the rest of the wand. Once the assembly of the tip of the intraoral scanner 300 is completed, the tip can be added to the wand. The tip may connect to the wand via mechanical interfaces (e.g., screws, springs, bolts, fasteners) and electrical connections (e.g., connect to internal portion of scanner). The tip of the intraoral scanner 300 may be a standalone item that is later integrated with the rest of the intraoral scanner 300 (e.g., endpiece, scanner). The intraoral scanner 300 may use multi-structured light to create a 3D model.

In some embodiments, the intraoral scanner 300 has one or more components 310 (e.g., cameras, projectors, LED lights, NIRI lights, etc.).

In some embodiments, the intraoral scanner has a lightguide projector 320. The lightguide projector 320 may include a light source 322 (e.g., laser device, LED source, NIRI source, etc.) and a lightguide structure 324 (e.g., layer of glass, plate of glass, etc.). The light source 322 may generate light and the lightguide structure 324 may receive the light from the light source 322.

In some embodiments, the light is to propagate through the lightguide structure along an elongated axis of the lightguide structure 324 via internal reflections. A portion (e.g., reflecting portion, diffracting portion) of the lightguide projector 320 may cause the light to exit the lightguide structure 324 to illuminate a mouth of a patient. A reflecting portion may be a mirror. A diffracting portion may be an out-coupler (e.g., a grating, grating is a diffractive element).

In some embodiments the components 310 include one or more projectors.

In some embodiments, a projector (e.g., non-distributed projector) may include components (e.g., diode, focusing optics, relay lens, folding prism, lens array, etc.) all disposed in one module (e.g., housing), that are bonded together, and/or that are less than a threshold distance from each other. The projector may include components (e.g., disposed less than a threshold distance from each other) that are configured to emit a first beam of light and generate first structured light.

In some embodiments, a projector (e.g., distributed projector) includes at least two modules (e.g., housings), such as a diode module including first components (e.g., diode, focusing optics) and a lens module including second components (e.g., relay lens, folding prism, lens array). Each of the modules (e.g., housings) may be disposed in different regions of the interior volume 308 of the probe housing 302. Each of the modules (e.g., housings) may not be bonded together and may be greater than a threshold distance from each other. The threshold distance may be at least 30 mm, at least 25 mm, at least 20 mm, at least 15 mm, at least 10 mm, or at least 5 mm. In some embodiments, the lens module is disposed at a distal end of the probe housing 302. In some embodiments, the distal end of the probe housing 302 has an angled tip that houses the lens module.

In some embodiments, the lightguide projector 320 is used instead of or in addition to projectors to illuminate a mouth fo a patient.

In some embodiments, one or more lightguide projectors 320 provide a first type of illumination (e.g., blue illumination) and a second type of illumination (e.g., green illumination). The multiple cameras and one or more lightguide projectors 320 may be used to provide sufficient data for 3D construction (e.g., 3D imaging) of the dental site.

In some embodiments, at least a portion of lightguide projector 320 may be disposed at or proximate to the window 306. The window 306 may cover at least a portion of the lightguide structure 324 without covering the light source 322. In some embodiments, the lightguide structure 324 is the window 306.

Light source 322 (e.g., laser device, diode, laser diode) may be configured to emit light 390 (e.g., a beam of light). The light source 322 may emit light 390 that is visible and/or light 390 that is infrared. The light source 322 may emit white light and/or NIRI. In some embodiments, the lightguide projector 320 replaces projectors, white LEDs, and/or NIRI LEDs. The lightguide projector 320 may be used with projectors, white LEDs, and/or NIRI LEDs. The cameras, lightguide projector 320, projectors (e.g., ultraminiature projectors, white LEDs, and/or NIRI LEDs) may be located in the tip (e.g., angled tip 303) of the intraoral scanner.

One or more of projectors may have the same or similar functionality, components, material, etc. as one or more of the ultraminiature pattern projectors described in U.S. patent application Ser. No. 18/226,651 to Atiya, et al. In some embodiments, each projector (e.g., structured light projector) includes a housing, within which is disposed a light source. In some embodiments the housing is a sealed housing (e.g., is hermetically sealed). Each light source includes at least one semiconductor laser die and at least one beam shaping optical element. In some embodiments, the semiconductor laser die and the beam shaping optical element are disposed within a common chamber of the housing. Placing the beam shaping optical element and the semiconductor laser die of the structured light projector within the same chamber of the housing enables a distance between an emission point of the semiconductor laser die and an input face of the beam shaping optical element to be shorter than conventional laser diodes permit. Distance D between an emission point of the semiconductor laser diode and an input face of the beam shaping optical element is at least 50 microns and/or less than 250 microns. Some examples of the advantages provided are: overall reduction in size of the structured light projector, in turn enabling a reduction in size of the probe as well as increased flexibility in the arrangement of the structured light projectors and the cameras; increased collection efficiency of the laser light; increased depth of focus of the structured light projector; use of multiple laser dies within a single structured light projector, increasing the quantity of structured light features used for 3D reconstruction without increasing the size of and/or number of structured light projectors; and/or reduced speckle noise when using multiple laser dies.

One or more portions of intraoral scanner may be configured to focus the light, deflect at least a first portion of the light, and/or generate (e.g., via a lens array or the lightguide structure 324), based on the at least a first portion of the light, structured light (e.g., a projected pattern) to illuminate at least a portion of a mouth of a patient.

In some embodiments, the light source 322 and the lightguide structure 324 may be distributed components that are used instead of pattern projectors (e.g., structured light projectors). This allows a smaller size of the tip of the intraoral scanner 300 while maintaining high field of view (FOV) and structured light cover area. The lightguide projector 320 provides light via a light source 322 (e.g., laser diode) placed on the back of the tip or the body of the scanner and the lightguide structure 324 in the tip. The lightguide projector 320 (e.g., split projector) may be referred to as a virtual projector (VP).

Light from light source 322 (e.g., semiconductor laser) may be coupled into one end of a lightguide structure 324 (e.g., layer of glass) wherein the light undergoes multiple internal reflections as the light propagates through the lightguide structure 324 and is focused and/or split into a 2-dimensional (2D) fan of beams by a lens or an out-coupler (e.g., grating coupler) on the other end of the lightguide structure 324. At out-coupler may be a grating, a metaurface, a lens array, etc. In some embodiments, the lightguide projector 320 includes a focusing out-coupler (e.g., focusing grating coupler).

The lightguide projector 320 (e.g., laser projector) may be embedded in the intraoral scanner 300. The lightguide projector 320 may be configured to provide light at optical frequencies. The lightguide structure 324 may be a flat glass plate that acts as a lightguide and transports light (e.g., laser rays) from a first end of the lightguide structure 324 to a second end of the lightguide structure 324 and into free space by an embedded grating coupler. A lens array (e.g., lens, MLA) may be integrated into the second end of the lightguide structure 324.

In some embodiments, a lightguide structure 324 may be used to transport a pattern of light (e.g., an image) from light source 322 (e.g., a display, micro-display) and project the image outward and into a mouth of a patient.

Conventional projectors include apertures and lenses that are mounted on top of a laser module. Conventional projectors are rather large and use additional infrastructure in close vicinity (e.g., electrical contacts, heat flow systems, etc.).

The lightguide projector 320 (e.g., embedded laser projector) of the present disclosure has a light source 322 (e.g., external laser source) that may be located at one edge of the lightguide structure 324 (e.g., glass layer) (e.g., far from an output coupler that may be located on the far end of the lightguide structure 324). At out-coupler (e.g., output coupler) may be any grating or reflecting surface that breaks the TIR condition and deflects light outside of the lightguide projector 320. The infrastructure (e.g., light source 322, etc.) being far from the output coupler (e.g., out-coupler) of the lightguide projector 320 may allow the distal end of the intraoral scanner 300 to be smaller than conventional scanners.

The output coupler (e.g., out-coupler) radiating the laser beam out of the intraoral scanner 300 may have a similar or smaller footprint than conventional laser module outputs. This may allow the radiating system of the intraoral scanner 300 to be part of the window 306 (e.g., covering window) of the intraoral scanner 300 which may have a width of about 1 millimeter. Having the output coupler (e.g., out-coupler) embedded in the window 306 may provide more degrees of freedom to the mechanical design and positioning of the outputs, which may allow output light radiation even from the edge of the window 306.

By using grating or a DOE as an output coupler (e.g., out-coupler), different output beam shapes (e.g., any output beam shape) may be designed.

Several wavelengths may be coupled into the lightguide structure 324 and output through the same or different output couplers (e.g., out-couplers). By using deflecting mechanical source, the deflection of beams with one or several wavelengths may be altered and controlled. This may give control over temporal, spatial, and spectral dependency of the output beam.

Many such outputs may be designed on the same lightguide structure 324 to provide different spot arrays (e.g., any spot array).

In some embodiments, the intraoral scanner 300 has a lightguide projector 320 that is an embedded laser projector for optical frequencies. Different embodiments of lightguide projectors 320 may be used. FIGS. 3A-41 may illustrate a single unit cell of a lightguide projector 320 which can be repeated and/or combined to form a radiating system of an intraoral scanner 300 (e.g., an intraoral scanner 300 may include one or more lightguide projectors 320 that may be the same or different from each other).

In some embodiments, at least a portion of the projection system or the entire projection system of an intraoral scanner 300 may be replaced by one or more lightguide projectors 320 (e.g., light guiding window). Light may be coupled in and out from the lightguide structure 324 according to specific requirements (e.g., image size, focus, field of view, etc.).

In some embodiments, a lightguide structure 324 is used to transport images from a light source 322 (e.g., micro display) and to project the images at a location outside of the lightguide structure 324 (e.g., a mouth of a patient). In some embodiments, a lightguide projector 320 may use one or more output couplers (e.g., out-couplers), such as partially transmitting mirrors, gratings, and/or metasurfaces. The partially transmitting mirror may be flat. For gratings and/or metasurfaces, feature size may be below the wavelength of impinging light and/or may have sub-wavelength height). In some embodiments, metasurfaces and gratings have a feature height (e.g., feature thickness) and a feature size. The feature size and height may be smaller than a wavelength (e.g., sub-wavelength). The grooves of the grating or the features of the metasurface may be smaller or of the order of magnitude of the wavelength.

Lightguide projectors 320 may be used to transport light 390 from a light source 322, such as cure light, intra-oral flashlight, and illumination for some imaging devices.

In some embodiments, lightguide structure 324 may be a flat lightguide configured to transport, radiate and shape light 390 from a light source 322 to a projected pattern 380 is used in a dental-oriented application (e.g., intra-oral scanners).

In some embodiments a lightguide projector 320 and lightguide structure 324 are different from a waveguide. The profile of a waveguide in at least one dimension is in the order of the wavelength of light. Therefore, a light beam keeps its form as it propagates in a waveguide. Lightguide projectors 320 are big compared to the wavelength of light, and therefore a light 390 (e.g., light beam) propagates in a lightguide structure 324 the same as the light 390 propagates in free space—the light 390 expands and changes lateral geometry. In some embodiments, the term waveguide is used to refer to a lightguide projector 320 or lightguide structure 324, unless the geometrical condition is explicitly mentioned.

In some embodiments, intraoral scanner 300 is a structured-light-based intraoral scanner.

By using a lightguide projector 320, the dimensions of the tip of the intraoral scanner 300 may be minimized. The lightguide projector 320 may have a much smaller height than conventional projectors. In some embodiments, the lightguide projector 320 has a height (e.g., width) that is less than 1 millimeter. The lightguide projector 320 may reduce heat produced in the tip of the intraoral scanner 300. This may be by placing the light source 322 on the back (where space is more available) and the lightguide structure 324 (which consumes low space) in the front.

The lightguide projector 320 is configured to emit a beam of light 390 (e.g., via light source 322), focus the beam of light 390, re-focus the beam of light 390, deflect the beam of light 390 (e.g., via reflection portion 332 and/or grating portion 336), and generate, based on the beam of light 390, a projected pattern 380 (e.g., via lens array 346). FIG. 3F may illustrate a probe housing 302.

The lightguide structure 324 may extend to a location proximate a distal end of the probe housing 302. The distal end of the probe housing 302 has an angled tip 303 that houses the lightguide structure 324. The angled tip 303 may have a lower height than a body of the probe housing 302.

In some embodiments, intraoral scanner 300 includes cameras configured to capture images. The images are to be used to perform model building via a correspondence algorithm or machine learning. In some embodiments, the optical components 310 (e.g., cameras) are configured to capture images of rearmost teeth in a mouth of a patient.

In some embodiments, the probe housing 302 forms an opening. The intraoral scanner may include a window 306 (e.g., window structure, structural window, optical window) coupled to the probe housing 302. The window 306 may cover the opening. The window 306 and the probe housing 302 may form the interior volume 308. In some embodiments, the optical components 310 (e.g., cameras, LEDs, and/or lightguide projector 320) may be disposed in the interior volume 308. In some embodiments, the lightguide projector 320 may be the window 306. One or more optical components 310 (e.g., cameras, LEDs, and/or lightguide projector 320) may be bonded directly to the window 306 (via an adhesive, via an adhesive that is optically permeable, a high-level anti-contamination sealing adhesive) and/or may be part of the window 306. The optical components 310 (e.g., cameras, LEDs, and/or lightguide projector 320) may be bonded directly to the window 306 to provide drift-free retention of the optical components 310.

In some embodiments, the intraoral scanner 300 includes a sleeve that includes an optical window (e.g., a sleeve window structure that is coupled to a sleeve housing). The sleeve may be configured to be removably disposed over the probe housing 302. The optical window of the sleeve may be configured to substantially align with the window 306 that is coupled to the probe housing 302. The intraoral scanner 300 (e.g., probe housing 302 and window structure 370) may be compatible with single piece disposable sleeve for cross contamination control.

The intraoral scanner 300 may have a reduced tip cross section compared to conventional scanners. This may provide increased maneuverability. The optical components 310 (e.g., cameras, LEDs, and/or lightguide projector 320) of the intraoral scanner 300 may be closer to the tip distal end than conventional scanners. This may allow imaging of rearmost molars. The intraoral scanner 300 may have tighter camera-projector overlap than conventional scanners. This may improve image capture quality and coverage. The intraoral scanner 300 may have optical components 310 (e.g., cameras, LEDs, and/or lightguide projector 320) distributed to provide triangulation diversity and reduced occlusions.

The intraoral scanner 300 may be inserted into a mouth of a patient until hitting a stop surface. The foremost capture aperture of the intraoral scanner 300 may reach deeper in a mouth of a patient than conventional scanners.

In some embodiments, probe housing 302 is a stainless-steel enclosure. In some embodiments, the sleeve is a transparent material and sleeve window is the same material as the rest of the sleeve (e.g., sleeve window and sleeve housing of sleeve are the same component). In some embodiments, sleeve window is transparent and is different from the sleeve housing of the sleeve (e.g., sleeve window and sleeve housing of sleeve are different components). An interface may couple the probe housing 302 to a wand body of the intraoral scanner 300.

An intraoral scanner 300 may include: an elongate handheld wand including a probe housing 302 at a distal end of the handheld wand; and one or more lightguide projectors 320 (e.g., structured light projectors) disposed within the probe housing 302, each lightguide projector 320 including a light source and a lightguide structure 324. The light source may include a semiconductor laser die and a beam shaping optical element. Each lightguide projector 320 may be configured to project a pattern of light onto an intraoral surface when the light source 322 of the lightguide projector 320 is activated to emit light through the pattern generating optical element of the lightguide structure 324. In some embodiments, the semiconductor laser die has a beam shaping optical element (e.g., within 50-250 microns of the emission point of the semiconductor laser die) and then the light is to propagate through the lightguide structure 324 and is to be outcoupled using a reflecting surface or a grating. In some embodiments, the semiconductor laser die is a bare die and the pattern generating optical element is located at the output coupler (e.g., out-coupler).

In some embodiments, the intraoral scanner 300 further includes one or more cameras disposed within the probe housing 302, where a distance between (i) an optical axis of at least one camera and (ii) an optical axis of a projected pattern 380 exiting a lightguide projector 320 that is adjacent the at least one camera is about 0-5 mm or is about 3-5 mm (e.g., if the output grating is located at the top of a camera, the distance may be effectively zero).

U.S. patent application Ser. No. 17/869,698 to Atiya, et al., published as US20230025243A1 to Atiya, et. al, is assigned to the assignee of the present application, and is incorporated herein by reference, describes an intraoral scanner with illumination sequencing and controlled polarization. The intraoral scanner 300 may have the one or more of the same or similar functionality, components, material, etc. as one or more of the embodiments described in U.S. patent application Ser. No. 17/869,698 to Atiya, et al. In some embodiments, a correspondence algorithm is used with the cameras and the one or more lightguide projectors 320 of intraoral scanner 300.

In some embodiments, each camera includes a camera sensor that has an array of pixels, for each of which there exists a corresponding ray in 3-D space originating from the pixel whose direction is towards an object being imaged; each point along a particular one of these rays, when imaged on the sensor, will fall on its corresponding respective pixel on the sensor. The term used for this may be a “camera ray.” Similarly, for each projected spot from each lightguide projector 320 there exists a corresponding projector ray. Each projector ray corresponds to a respective path of pixels on at least one of the camera sensors, i.e., if a camera sees a spot projected by a specific projector ray, that spot is detected by a pixel on the specific path of pixels that corresponds to that specific projector ray. Values for (a) the camera ray corresponding to each pixel on the camera sensor of each of the cameras, and (b) the projector ray corresponding to each of the projected spots of light from each of the lightguide projectors 320, may be stored during a calibration process.

In some embodiments, based on the stored calibration values a processing device may be used to run an algorithm in order to identify a 3D location for each projected spot on the surface. For a given projector ray, the processing device “looks” at the corresponding camera sensor path on one of the cameras. Each detected spot along that camera sensor path will have a camera ray that intersects the given projector ray. That intersection defines a 3D point in space. The processing device then searches among the camera sensor paths that correspond to that given projector ray on the other cameras and identifies how many other cameras, on their respective camera sensor paths corresponding to the given projector ray, also detected a spot whose camera ray intersects with that 3D point in space. If two or more cameras detect spots whose respective camera rays intersect a given projector ray at the same 3D point in space, the cameras are considered to “agree” on the spot being located at that 3D point. Accordingly, the processing device may identify 3D locations of the projected light (e.g., projected) pattern of light) based on agreements of the two or more cameras on there being the projected pattern of light by projector rays at certain intersections. The process is repeated for the additional spots along a camera sensor path, and the spot for which the highest number of cameras “agree” is identified as the spot that is being projected onto the surface from the given projector ray. A 3D position on the surface is thus computed for that spot. In some embodiments, a processing device may use a 3D reconstruction algorithm for 3D map reconstruction based on spots, which may provide the 3D model. In some embodiments, a processing device may use a correspondence algorithm to identify spots (e.g., may not compute the 3D map by itself).

In some embodiments, once a position on the surface is determined for a specific spot, the light 390 (e.g., projector ray) that projected that spot, as well as all camera rays corresponding to that spot, may be removed from consideration and an algorithm (e.g., the 3D reconstruction algorithm, the correspondence algorithm) may be run again for a next projector ray. Ultimately, the identified 3D locations may be used to generate a digital 3D model of the intraoral surface.

International Patent Application No. PCT/US2023/021390 to Fain, et. al, published as WO2023229834A1 to Fain, et. al, is assigned to the assignee of the present application, and is incorporated herein by reference, describes an intraoral scanner. The intraoral scanner of the present disclosure may have one or more of the same or similar functionality, components, material, etc. as one or more of the embodiments described in PCT/US2023/021390 to Fain, et al.

U.S. Patent Application No. 63/461,804 to Dafna, et al., is assigned to the assignee of the present application, and is incorporated herein by reference, describes determining 3D data for 2D points using machine learning. The intraoral scanner 300 may have the same or similar functionality, components, material, etc. as one or more of the embodiments described in U.S. Patent Application No. 63/461,804 to Dafna, et al. In some embodiments, machine learning is used with the cameras and the projectors of intraoral scanner 300 to determine 3D data (e.g., modeling of a dental arch) using 2D points.

In some embodiments, a method includes projecting, by one or more lightguide projectors 320 (e.g., structured light lightguide projectors) of an intraoral scanner 300, a light pattern including projector rays onto a dental site. The method may further include capturing, by cameras of the intraoral scanner 300, images of at least a portion of the light pattern projected onto the dental site, where each camera captures an image including points of at least the portion of the light pattern projected onto the dental site. The method may further include determining, for each projector ray, one or more candidate points that might have been caused by the projector ray.

In some embodiments, the method includes: processing information for each projector ray using a trained machine learning model, where the trained machine learning model generates one or more outputs including, for each projector ray, and for each candidate point associated with the projector ray, a probability that the candidate point corresponds to the projector ray; and determining 3D coordinates for at least some of the points in the images based on the one or more outputs of the trained machine learning model.

In some embodiments, the method includes: using a trained machine learning model to select candidate points for projector rays based on one or more inputs including probabilities of candidate points corresponding to projector rays; and determining 3D coordinates for at least some of the points in the images based on the selected candidate points for the plurality of projector rays.

In some embodiments, a method includes: using a first trained machine learning model to determine probabilities that captured points of a captured light pattern in one or more images correspond to projected points of a projected light pattern; using a second trained machine learning model to determine correspondence between a plurality of the captured points and the projected points based on one or more of the determined probabilities; and determining depth information for at least some of the plurality of captured points based on the determined correspondence.

In some embodiments, a method includes: using one or more trained machine learning models to determine correspondence between captured points of a captured light pattern in images and projected points of a projected light pattern; and determining depth information for at least some of the plurality of captured points based on the determined correspondence.

A waveguide (e.g., see International Patent Application No. PCT/US2023/021390 to Fain, et. al, published as WO2023229834A1 to Fain, et. al, incorporated herein by reference in its entirety) may refer to a channel where a ray of light is confined to a small space. In the waveguide, the ray of light stays in the channel without expanding. In a waveguide, the ray of light may travel along a long axis of the waveguide. The small axis of the waveguide may be perpendicular to the long axis of the wave guide. The small axis may be a micron in height, one pixel, single ray of light, etc. The small axis may be perpendicular to the ray of light propagation (e.g., the cross section of the channel may be small and the propagation axis may be large, the cross section of the channel may be smaller than the propagation axis). The waveguide may bend the ray of light like a fiber. The ray of light may exit the end of the waveguide.

A lightguide structure 324 may refer to a slab of glass where light 390 is not confined as much as a waveguide. One or more surfaces of the lightguide structure 324 (e.g., lower boundary of the slab) may reflect the light 390 and one or more components of the lightguide projector 320 may focus, manipulate, and/or resend the light 390. A lightguide projector 320 may be much larger than a waveguide. Light 390 in a lightguide structure 324 may be much larger and freer (e.g., expand in dimension(s) than in a waveguide. The lightguide projector 320 may generate a projected pattern 380 via grating. The lightguide projector 320 may project an entire pattern through the lightguide structure 324 and/or may generate the pattern at the end of the lightguide projector 320. The lightguide projector 320 may propagate the light 390 via internal reflections within the lightguide structure 324. The lightguide projector 320 (e.g., lightguide structure 324) may be one millimeter or larger in thickness. The lightguide projector 320 may include a light source (e.g., laser) at one end and may direct the light 390 from the light source 322 through the lightguide structure 324 (e.g., reflective coating causes the light 390 to exit the lightguide projector 320). The reflective coating may be metallic (e.g., silver, aluminum, etc.) to reflect the light 390. The reflective coating may cause the light 390 to go through the lens array 346 (e.g., MLA). The reflective coating may break the condition of bouncing light 390 (e.g., TIR) to direct the light 390 so that it does not bounce anymore and may focus the light 390. The light 390 may hit different points on the reflective coating (e.g., curved mirror) and the reflective coating may focus the light 390 (e.g., focusing beam). In the lightguide structure 324, the light 390 may be expanded and/or focused.

In some embodiments, the intraoral scanner 300 includes a lens array that is at least one of a multi lens array (MLA) or a diffractive optical element (DOE). In some embodiments, a grating of the lightguide structure 324 forms the structured light (e.g., projected pattern). The lightguide projector 320 may have surface grating that stops the TIR and projects the light 390 out of the lightguide structure 324 and through a lens array 346.

In some embodiments, the lens array 346 is an MLA (e.g., responsive to the lightguide projector 320 replacing projectors). In some embodiments, the lens array 346 is a diffuser (e.g., responsive to the lightguide projector 320 replacing LEDs).

In some embodiments, there may be one exit (e.g., via surface grating, etc.) per region or there may be multiple beam exits by appropriate grating design. In some embodiments, there may be one exit of light 390 per region via one reflecting portion 332 (e.g., reflective plane) and lens array 346 or there may be multiple exits of light 390 via semi-reflective planes (e.g., reflecting portion(s) 332, multiple mirrors) and multiple lens arrays 346. The lens array 346 may be an MLA (e.g., for light conventionally provided by projectors), a white LED diffuser (e.g., for light conventionally provided by white LEDs), a NIRI LED diffuser (e.g., for light conventionally provided by NIRI LEDs), and/or the like. In some embodiments, the light source 322 is coupled to an actuator (e.g., MEMS) that actuates the light source 322 to provide the light 390 in different trajectories (e.g., across an angular range and resolution of the MEMS) through the lightguide structure 324 (e.g., to different grating portions 336).

FIG. 3B illustrates a side view of a lightguide projector 320. Lightguide projector 320 may have a light source 322 that generates light and a lightguide structure 324 that receives the light from the light source 322.

In some embodiments, a lightguide structure 324 is an elongated slab of material that has a refractive index (n) higher than the refractive index of the surrounding material. Light propagates through the lightguide structure 324 along an elongated axis of the lightguide structure 324 by total internal reflection (TIR). If the angle of incidence (θ) of light through the material meets a threshold value (e.g., is high enough), the TIR condition is fulfilled and light bounces onward within the lightguide structure 324 (e.g., slab) instead of radiating out of the lightguide structure 324.

The dimension of the lightguide in the perpendicular axis (d) may be about 1 mm. The lightguide structure 324 may function according to the following equation:

### TIR Condition:

$$θ \geq {sin}^{- 1} \frac{{n}_{0}}{{n}_{1}}$$

The refractive index of the lightguide structure 324 may be n₁ and the refractive index of the surrounding material may be n₀. The refractive index (n₁) of the lightguide structure 324 may be greater than the refractive index (n₀) of the surrounding material (e.g., n₁>n₀).

FIG. 3C illustrates a side view of a lightguide projector 320. Lightguide projector 320 may include a light source 322 (e.g., semiconductor laser device, laser device) configured to provide light 390 (e.g., a laser beam, beam of light) and a lightguide structure 324 (e.g., made of glass, polymer, silicon, and/or silicon dioxide (SiO₂) configured to receive the light 390. In some embodiments, the lightguide structure 324 is made of a material that is transparent to the wavelength of the light, where the material has a refractive index higher than surrounding environment. In some embodiments, for infra-red light, silicon is very broadly used for the material of the lightguide structure 324.

An in-coupler structure 330 may be disposed between the light source 322 and the lightguide structure 324. The in-coupler structure 330 may be a prism, a diffractive optical element (DOE) (e.g., grating), and/or an edge coupler (e.g., combination of prism and grating). An edge coupler may be a facet of the lightguide projector 320 (e.g., facet of the lightguide structure 324) and the laser is to be placed in an angle to the facet such that the TIR condition is to be fulfilled (e.g., light bounces onward within the lightguide structure 324 instead of radiating out of the lightguide structure 324). A prism may be material (e.g., that has a triangular perimeter, that has a rectangular perimeter, etc.) that protrudes from the lightguide structure 324. The prism may be of the same or different material as the lightguide structure 324.

In some embodiments, the light 390 (e.g., beam) propagates through the lightguide structure 324 by total internal reflections (TIR) and reaches a reflecting portion 332 (e.g., curved mirror, reflecting mirror) which may be a part of the lightguide structure 324 (e.g., lightguide substrate) covered with a reflecting coating. The reflecting portion 332 is configured to focus light to a distance 340 (e.g., about 10 mm, distance f) so that the light 390 (e.g., beam) is reflected substantially perpendicularly to the lightguide elongated axis and focused outside of the lightguide structure 324. Once the light 390 exits the surface of the lightguide structure 324, the light 390 (e.g., beam) propagates through a lens array 346 (e.g., micro-lens array (MLA)) and is diffracted and split into a projected pattern 380 (e.g., an array of spots). The height of the lightguide structure 324 and/or lightguide projector 320 may be a distance 342 (e.g., about 1 mm). The width of the lightguide structure 324 and/or lightguide projector 320 may be about several centimeters. The width of the lens array 346 may be a distance 344 (e.g., about 200 micro-meters).

The reflecting portion 332 (e.g., curved mirror) may be a reflecting mirror element. The reflecting mirror element may be fabricated at the bottom edge of the lightguide structure 324. The reflecting mirror element may deflect and focus the TIR light substantially perpendicularly to the lightguide elongated axis and out of the lightguide structure 324. The reflecting mirror element may be situated in contact with the lightguide structure 324 or may be a part of the material of the lightguide structure 324. In both cases the reflecting mirror element may be covered with a reflecting coating which acts as a mirror.

A lens array 346 (e.g., MLA) may be situated at the end of the lightguide structure 324 opposite to the mirror to diffract the light 390 (e.g., out-coupled ray) and split the light 390 into a projected pattern 380 (e.g., an array of spots). The lens array 346 (e.g., MLA) may also be integrated on top or within the lightguide structure 324 (e.g., lightguide substrate).

FIG. 3D illustrates a side view of a lightguide projector 320. The lightguide projector 320 may include a light source 322 configured to generate light 390, a lightguide structure 324 to receive the light 390, and an in-coupler structure 330 disposed between the light source 322 and the lightguide structure 324 (e.g., the light 390 is provided from light source 322 to lightguide structure 324 through the in-coupler structure 330.

The lightguide projector 320 may have a reflecting portion 332 that is a partially reflecting mirror element. The partially reflecting mirror element may be fabricated within the lightguide structure 324 (e.g., within the volume and along the lightguide structure 324). The reflecting portion 332 reflects the at least a portion of light 390 (e.g., TIR light beam) out of the lightguide structure 324. The reflecting portion 332 (e.g., reflecting surface) may be curved to act as a focusing mirror so that the reflected light 390 (e.g., reflected beam) is focused. A lens array 346 (e.g., MLA) on the lightguide structure 324 may introduce splitting of the focused light (e.g., focused beam) to a projected pattern 380 (e.g., an array of spots). The reflecting portion 332 may be partially reflecting which allows some of the light 390 (e.g., beam) to continue propagating through the lightguide structure 324. The far-most wall of the lightguide structure 324 (e.g., opposite the other far-most wall proximate the light source 322) may act as a reflecting surface.

FIG. 3E illustrates a side view of a lightguide projector 320. The lightguide projector 320 may include a light source 322 configured to generate light 390, a lightguide structure 324 to receive the light 390, and an in-coupler structure 330 disposed between the light source 322 and the lightguide structure 324 (e.g., the light 390 is provided from light source 322 to lightguide structure 324 through the in-coupler structure 330.

Light 390 (e.g., beam) of a light source 322 (e.g., semiconductor laser device) may be coupled into the lightguide structure 324 through an in-coupler structure 330 and propagates along the lightguide structure 324. The light 390 (e.g., beam) encounters a reflecting portion 332 that may be a partially reflecting curved surface embedded within the lightguide structure 324. The partially reflecting curved surface may act as a mirror and reflects and focuses the light 390 (e.g., beam of light) to a location outside of the lightguide structure 324 (e.g., perpendicularly or in an angle to the elongated axis of the lightguide structure 324). A lens array 346 (e.g., MLA) may be located on the lightguide structure 324 to split the light 390 (e.g., beam) into a projected pattern 380 (e.g., array of focused spots). The partially reflecting curved surface may be made by two different components secured together (e.g., brought to contact) to form the lightguide structure 324.

FIG. 3F illustrates a side view of a lightguide projector 320. The lightguide projector 320 may include a light source 322 configured to generate light 390, a lightguide structure 324 to receive the light 390, and an in-coupler structure 330 disposed between the light source 322 and the lightguide structure 324 (e.g., the light 390 is provided from light source 322 to lightguide structure 324 through the in-coupler structure 330.

Light 390 (e.g., beam) of a light source 322 (e.g., semiconductor laser device) may be coupled into the lightguide structure 324 through an in-coupler structure 330 and propagates along the lightguide structure 324. The light 390 (e.g., beam) encounters a reflecting portion 332 that may be a partially reflecting curved surface. A lens 334 may be disposed between the light source 322 and the in-coupler structure 330. The lens 334 may focus the light 390 received from light source 322 before the light 390 passes through the in-coupler structure 330 into the lightguide structure 324.

The light 390 (e.g., beam) propagates through the lightguide structure 324 and encounters a reflection portion 332 that is a structure that is designed to break the TIR condition and couple the light 390 (e.g., beam) out of the lightguide structure 324. The reflecting portion 332 (e.g., structure) may be a prism or an angle-dependent geometrical structure. The reflection portion 332 (e.g., structure) may be at the top, bottom or at the far-most wall of the lightguide structure 324. The reflection portion 332 (e.g., structure) may be of a different refractive index than the lightguide structure 324, and as such a separate structure, or the reflection portion 332 (e.g., structure) may be a part of the lightguide structure 324 (e.g., lightguide substrate) and as such have a similar refractive index as that of the lightguide structure 324. Once the light 390 is coupled out, the light 390 passes through a lens array 346 (e.g., MLA) to split into a projected pattern 380 (e.g., an array of spots).

The reflecting portion 332 may be a prism element that is located at the top or bottom side of the lightguide structure 324 and radiates light 390 out by breaking the TIR condition. The prism element may be of the same, or different refractive index as that of the material of the lightguide structure 324. As such, the prism may be separate or a part of the lightguide structure 324. If located at the bottom of the lightguide structure, the prism may have a reflecting coating to reflect light 390 upwards (e.g., similar to the reflecting mirror). The light 390 may be focused prior to coupling in. In some embodiments, a lens (e.g., refractive lens or a meta-lens) may be used between the reflecting portion 332 (e.g., prism surface) and the lens array 346 (e.g., MLA). The lens array 346 (e.g., MLA) may be disposed above the lightguide structure 324 and reflecting portion 332 (e.g., prism) and may further splits the light 390 (e.g., beam) to a projected pattern 380 (e.g., an array of spots). The reflecting portion 332 (e.g., prism) may be located at the far end of the lightguide structure 324 and may act as the far-most surface (wall) of the lightguide structure 324.

FIG. 3G-H illustrate side views of lightguide projectors 320. The lightguide projector 320 may include a lightguide structure 324 to receive light 390 (e.g., from a light source 322). The light may reflect through lightguide structure 324 and a grating portion 336 (e.g., reflecting portion 332) may cause the light 390 to exit the lightguide structure 324.

The grating portion 336 may be a diffraction grating. The diffraction grating may be integrated at either side (e.g., upper side, lower side) of the lightguide structure 324. Once the light 390 (e.g., ray) hits the grating portion 336, the light 390 may be diffracted according to the grating equation:

$${n}_{1} sin {θ}_{i n} = {n}_{0} sin {θ}_{o u t} + \frac{λ m}{Λ}$$

The variable Λ is the grating period, and the variable of λ is the wavelength. The angle of the incident beam changes which causes the TIR condition to no longer be valid and the light 390 (e.g., beam) is radiated out of the lightguide structure 324. The period of the grating portion 336 and the depth of the grating portion 336 may be of the order of the wavelength (e.g., less than 1 micrometer). The grating portion 336 (e.g., at a shallow depth, at less than a threshold depth, for large groove depth designed for this purpose, etc.) may have a lesser effect on the see-through light and the part of the light 390 that is affected is diffracted into the lightguide structure 324 as TIR light. Thus, the grating portion 336 may be transparent when visioned perpendicularly.

In some embodiments, the grating portion 336 includes surface relief grating (e.g., etched into the lightguide structure 324 or into an additional layer). This grating portion 336 can be square, slanted, blazed, and/or other surface relief grating.

In some embodiments, the grating portion 336 includes an ion doping (e.g., ion implantation) within the lightguide structure 324 (e.g., substrate).

In some embodiments, the grating portion 336 is a photo-sensitive polymer on the surface plane or a surface within the lightguide structure 324 (e.g., substrate).

FIG. 3G illustrates the grating portion 336 at an upper side of the lightguide structure 324 and FIG. 3H illustrates the lightguide structure 324 at a lower side of the lightguide structure 324.

FIG. 3H illustrates a side view of a lightguide projector 320. Light 390 entering lightguide structure 324 may be referred to as in-coupled and light 390 exiting the lightguide structure 324 may be referred to as out-coupled. At the out-coupling (e.g., exiting) of light 390 from the lightguide structure 324, the light 390 (e.g., beam) may diverge. In some embodiments, the light 390 (e.g., beam) may focused prior to entering (e.g., the coupling into) the lightguide structure 324 by using a separate lens or a meta-lens. A lens array 346 (e.g., MLA) can also be used prior to entering (e.g., coupling-in) the lightguide structure 324 to split the light 390 (e.g., beam) (e.g., to cause the light to be a projected pattern 380).

In some embodiments, the grating portion 336 may be configured to be a focusing grating coupler to couple out (e.g., cause the light 390 to exit) and focus the light 390. A lens array 346 (e.g., MLA) may be situated above to split the light 390 (e.g., beam) to a projected pattern 380 (e.g., an array of spots).

In some embodiments, the grating portion 336 may be configured to couple out, focus, and split the light 390 (e.g., beam) to a projected pattern 380 (e.g., an array of spots).

In some embodiments, the grating portion 336 is numerically configured to radiate in a specific projected pattern 380 based on the holographic principle. In that case, the grating portion 336 may be a general diffractive optical element (DOE) with a specific pattern (e.g., including but not solely a grating).

FIGS. 3I-L illustrates side views of lightguide projectors 320. The lightguide projectors 320 may have different ways of receiving light 390 (e.g., in-coupling schemes) into the lightguide structures 324.

FIG. 3I illustrates a side view of a lightguide projector 320. A reflecting portion 332 (e.g., prism) with a different or the same refractive index is situated in contact with the lightguide structure 324. The passage through the reflecting portion 332 (e.g., prism) allows the light 390 (e.g., light ray) to achieve an angle for TIR condition.

FIG. 3J illustrates a side view of a lightguide projector 320. A grating portion 336 (e.g., at the inlet and/or the outlet) that diffracts the light 390 (e.g., incident beam) into the lightguide structure 324 in an angle that agrees with the TIR condition. The grating portion 336 can be located at either side of the lightguide structure 324.

This grating portion 336 may be an focusing grating coupler (FGC) to also focus the light 390. An FGC may couple (e.g., direct) the light into or out of the lightguide structure 324 and may also focus the light (e.g., to a focal distance). The FGC may include an array of curved grooved and/or chirped grooves (e.g., period of the groove varies along the length of the groove). In some embodiments, the FGC splits the light 390 into a projected pattern 380 (e.g., array of spots).

FIG. 3K illustrates a side view of a lightguide projector 320. Light 390 can be incident on the edge of the lightguide structure 324 such that the light 390 will refract into the lightguide structure 324 in an angle that agrees with the TIR condition. The edge may be in a shape that facilitates this, such as a prism. A non-reflecting coating on the facet may help coupling in (e.g., non-reflecting coating may prevent reflections so the light is coupled more fully into the lightguide structure 324.).

FIG. 3L illustrates a side view of a lightguide projector 320. Light 390 may enter the lightguide structure 324 and may reflect off of an angled side (e.g., reflecting portion 332) of the lightguide structure 324. The reflecting portion 332 may be for an angles design so that a TIR condition is fulfilled (e.g., light bounce off of the angled facet and be coupled in).

FIGS. 3M-O illustrates side views of lightguide projectors 320. A lightguide projector 320 may receive and/or propagate different light 390 (e.g., different light beams, have spectral dependency, etc.).

Gratings may be wavelength dependent. Light 390 (e.g., light beams) that have different wavelengths may diffract in different angles. This can be used to out-couple light 390 (e.g., light beams) with different wavelengths in different locations from the out-coupler grating (e.g., grating portion 336, see FIG. 3M). The grating portion 336 may be designed to allow different light 390 to exit the lightguide structure 324 at different locations of the grating portion 336.

Referring to FIG. 3N, two lightguide structures 324 may be used, each with an in-coupling grating (e.g., grating portion 336) that is configured for light 390 of a first wavelength, leaving light 390 of a second wavelength unaffected. By doing so, out-coupling may be done in substantially the same location (e.g., grating portion 336).

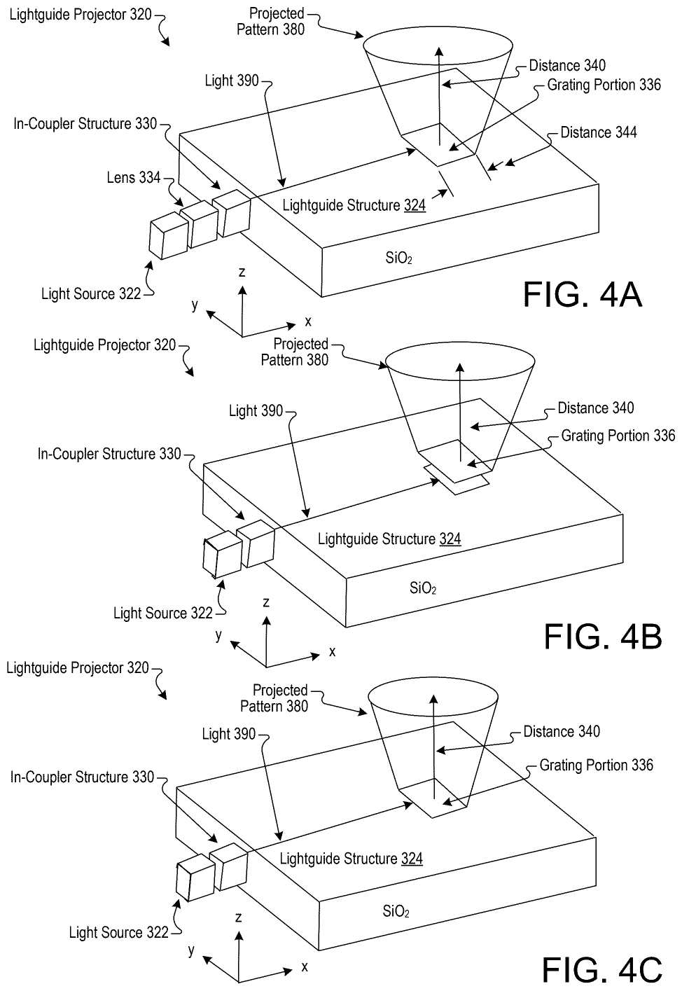

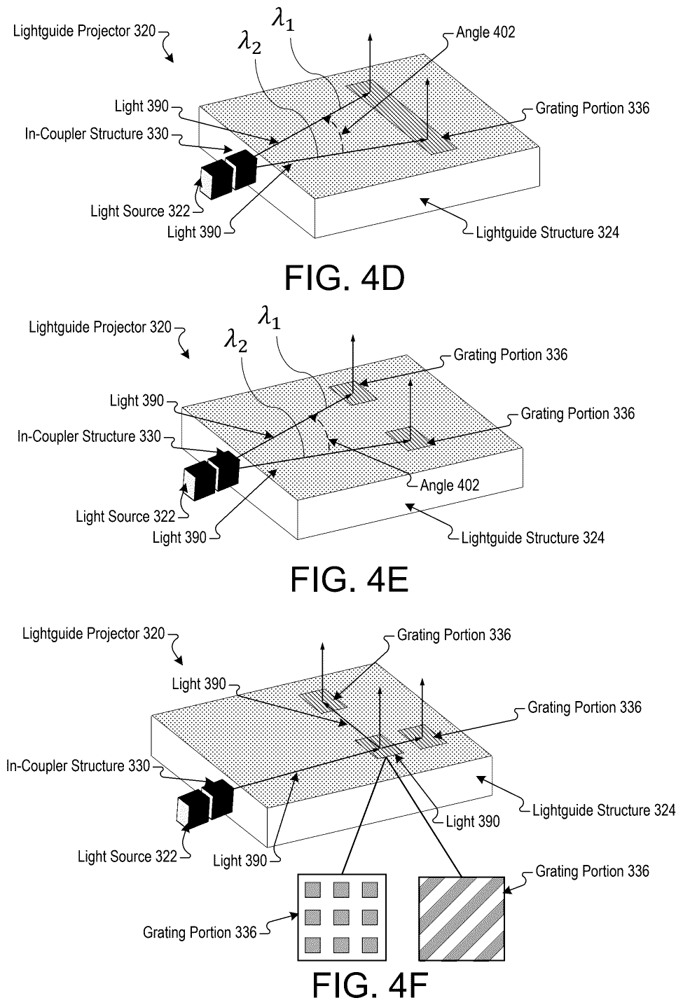

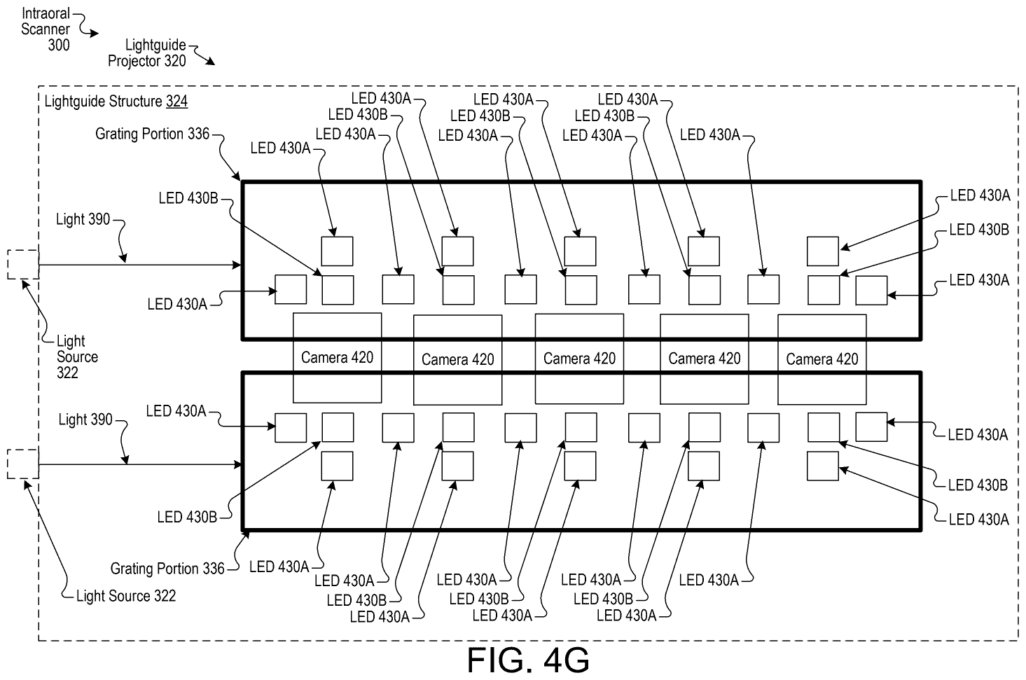

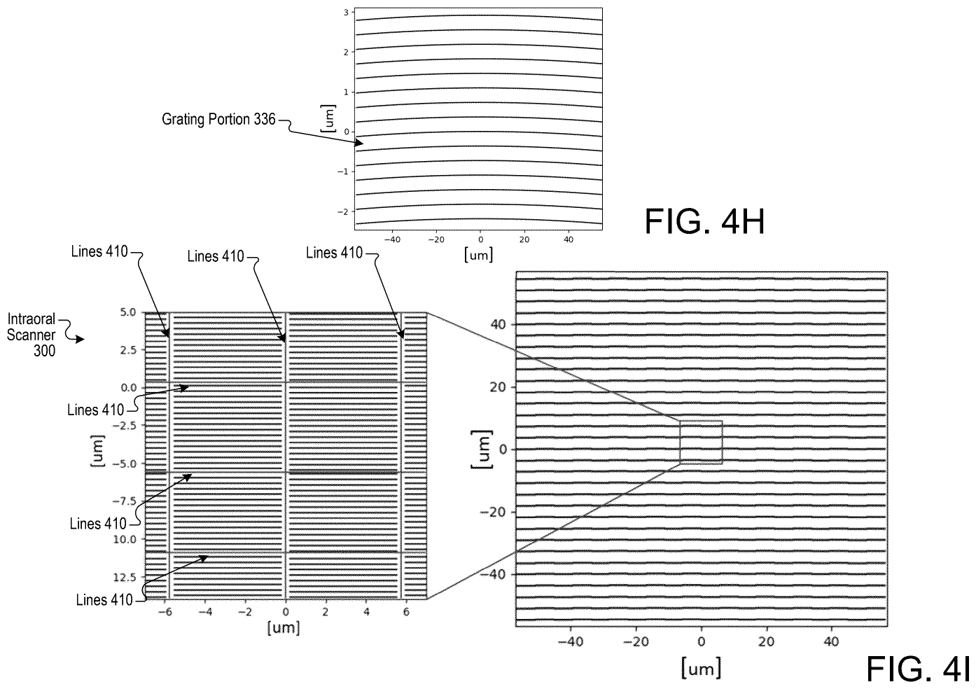

Referring to FIG. 3O, the out-coupling grating efficiency may be diminished (e.g., by shallow groove depth). The light 390 (e.g., internal beam) can continue propagating and can be coupled out once at a different location. Beyond being split in the same incident direction, the light 390 (e.g., beam) can be split and deflected to another direction by using a 1-dimensional (1D) grating of which the grooves are aligned in an oblique angle to the incident axis or by using a two-dimensional (2D) grating (e.g., a 2D array of elements instead of linear grooves (e.g., see FIG. 4F).

FIGS. 4A-I illustrate views of components of intraoral scanners (e.g., that have a lightguide projector), according to certain embodiments. In some embodiments, components of intraoral scanners of one or more of FIGS. 4A-I include similar or the same functionality, components, materials, and/or the like as components of one or more of scanner 150 of FIG. 1, intraoral scanner 20 of FIGS. 2A-D, and/or intraoral scanner 300 of FIGS. 3A-O. In some embodiments, intraoral scanners may provide beams of light 390 of different wavelengths. For example, beam of light 390A may be 450 nanometers (nm) (blue) and beam of light 390B may be 520 nm (green).

FIG. 4A illustrates a perspective view of a lightguide projector 320. Light 390 from a light source 322 (e.g., semiconductor laser) enters a lightguide structure 324 (e.g., is coupled) through an in-coupler structure 330. A lens 334 may be disposed between the light source 322 and the in-coupler structure 330 to focus the light 390. The light 390 (e.g., beam) may exit (e.g., be coupled out of) the lightguide structure 324 via a grating portion 336 (e.g., grating coupler) located at a particular location at the surface or within the lightguide structure 324 (e.g., lightguide substrate). The grating portion 336 may be a 2-dimensional array of structures (e.g., micro-lens array (MLA)) integrated within or as a layer on top of the lightguide structure 324. The grating portion 336 may be made via fabrication, E-beam lithography, ultraviolet (UV) lithography, nanoimprint, doping, and/or photo-sensitive polymer. The grating portion 336 may cause the light 390 (e.g., beam) to exit (e.g., couple the light 390 out of) the lightguide structure 324 and the light 390 may be diffracted and split into a projected pattern 380 (e.g., array of spots, via the grating portion 336). The focal length of the lens (e.g., lens 334) may be the optical path from the light source 322 (e.g., laser source) and into the location of the projected pattern 380 (e.g., spot array) on the z-axis. The lightguide projector 320 may have a lens array 346 located proximate the grating portion 336. The grating portion 336 may be a lens array 346 (e.g., MLA).

FIG. 4B illustrates a perspective view of a lightguide projector 320 (e.g., that has a focusing grating coupler and an MLA). Lightguide projector 320 may include a light source 322 (e.g., semiconductor laser) and an in-coupler structure 330. The grating portion 336 (e.g., out-coupler grating) may be a focusing grating coupler (FGC). This grating portion 336 is an array of curved grooves (e.g., recesses that form a curved perimeter) and chirped grooves that may have an average period of the scale of the wavelength of light 390 and the depth of the grooves is typically of tens to hundreds of nanometers. The grooves (e.g., chirped grooves) may have a period that varies along the length of the groove. The period of the grooves (e.g., chirped grooves) may vary in any manner, linear or non-linear, depending on the specific design. The grooves (e.g., chirped grooves) may become wider or narrower or both at different locations. The grooves may reflect a broad range of wavelengths (e.g., grooves can be designed for either a single wavelength or a broad range of wavelengths) A grating can be designed for a single wavelength while not effecting others or the grating can be designed for a broad range. Grooves of an FGC are depicted as single curves in FIG. 4H. This configuration causes the light 390 (e.g., propagating beam) to be coupled out of the plane of the lightguide structure 324 (e.g., lightguide plane) and into free space and to focus at a focal distance (f) in the z-axis (e.g., according to the holographic principle). The period and the curvature of the grooves of the grating portion 336 may be configured for a desired laser wavelength, focal distance, and an output angle between the focal distance and the z-axis.

FIG. 4C illustrates a perspective view of a lightguide projector 320 (e.g., lightguide projector that has an FGC that splits the light 390 into a projected pattern 380). The lightguide projector 320 may include a light source 322 (e.g., semiconductor laser), an in-coupler structure 330, and a grating portion 336 (e.g., an out-coupler). The grating portion 336 is a multibeam focusing grating coupler that both focuses and splits the light 390 (e.g., beam of light) into a projected pattern 380 (e.g., array of spots). This may be a variation of the FGC in FIG. 4B. The lightguide projector 320 of FIG. 4C may introduce an additional periodicity in the FGC pattern. The FGC region may be divided into a grid (e.g., 10×10 squares), where in each square, the grooves are dislocated (e.g., by about 100 nanometers) along the x-axis with respect to the neighboring squares.

The inset of FIG. 4I presents a part of such an FGC within the entire structure. Different sections are noted by lines 410 and the curves within each section are translated in the vertical axis compared to the adjacent sections. This modification of the FGC pattern causes the out-coupled light 390 (e.g., beam) to split into different focused beams (e.g., 9 different focused beams, 50 different focused beams, etc.) with the same focal distance as the out-coupled light (e.g., beam) of an unperturbed FGC). The light 390 (e.g., beams) may be equally spaced (e.g., in a 3×3 squared array).

The lightguide projector 320 may have a lightguide structure 324 (e.g., lightguide substrate) that is made of SiO₂ or other substantially transparent dielectric material with refractive index higher than the surrounding refractive index.

The lightguide projector 320 may have a light source 322 that is a coherent (e.g., laser) or non-coherent (e.g., SLM (spatial light modulator), DLP (digital light projector)) source.

The lightguide projector 320 may have an in-coupler structure 330 that may be a prism, DOE (e.g., grating), or edge's plane (e.g., surface of the lightguide structure 324).

The lightguide projector 320 may have an out-coupler structure that may be a lens, grating, etc.

If coherent light 390 is to be focused prior to coupling into the lightguide structure 324, an additional lens is to be used at the source output. This may be a refractive lens or a meta-lens.

If a non-coherent micro-display source is used, a projecting system is to be used prior to coupling into the lightguide structure 324.

FIGS. 4D-E illustrate perspective views of lightguide projectors 320. In some embodiments, a lightguide projector 320 has spatial separation (e.g., of light 390 or beams of light 390).

Two or more light sources 322 may radiate to a single or multiple out-couplers as depicted in FIGS. 4D-E. The light sources 322 may provide light 390 of different wavelengths and each may radiate to a different location as shown in FIGS. 4D-E. The light source 322 may be dynamic (e.g., adjust the angle 402 that the light 390 is directed into the lightguide structure 324, move along the side of the lightguide structure 324, etc.) so that the light 390 (e.g., beam) is translated and outcoupled from different locations (e.g., continuously, substantially continuously, sequentially, etc.). An intraoral scanner based on lightguide structures 324 may be configured in a bow-shaped (e.g., curved) manner. In some embodiments, the intraoral scanner may include a first portion that includes a first grating portion 336 configured to receive first light 390 and a second portion that includes a second grating portion 336 configured to receive second light 390. The first portion and the second portion of the intraoral scanner may include a corresponding portion of lightguide structure 324. The first portion and the second portion may be curved (e.g., bent, concave, convex, crescent-shaped, etc.) relative to each other. In some embodiments, there are two lightguide projectors, a first lightguide projector that is tilted compared to a second lightguide projector with an elongated axis of the first lightguide projector as the tilting axis. In some embodiments, first light is to exit the lightguide structure at a first portion of the lightguide structure and second light is to exit the lightguide structure at the first portion of the lightguide structure (the first light and the second light exit the lightguide structure at the same location).

FIG. 4F illustrates a perspective view of a lightguide projector 320 (e.g., see FIG. 3O). the lightguide structure 324 may have different grating portions 336 that have different patterns. A grating portion 336 may direct a portion of light 390 out of the lightguide structure 324 and cause a remaining portion of the light 390 to refract within the lightguide structure 324 (e.g., and exit the lightguide structure 324 at a different grating portion 336, refract to another direction without coupling out some of the light, etc.).

FIG. 4G illustrates a bottom view of an intraoral scanner 300 (e.g., distal end of an elongate wand) that includes a lightguide projector 320. The intraoral scanner 300 may include one or more cameras 420, LEDs 430A (e.g., white LED lights), LEDs 430B (e.g., NIRI LED lights), etc. The lightguide projector 320 may include one or more light sources 322, one or more lightguide structures 324. Each lightguide structure 324 may have one or more grating portions 336 that cause light 390 to become a projected pattern (e.g., projected pattern 380).

In some examples, two light sources 322 may be coupled to a single lightguide structure 324 that includes multiple grating portions 336, where a first grating portion 336 causes first light 390 from a first light source 322 to become a first projected pattern 380 and a second grating portion 336 causes second light 390 from a second light source 322 to become a second projected pattern 380. In some embodiments, the first light and the second light are different types of light that have one or more of different wavelengths, different angles, and/or different spatial distributions. In some embodiments, a first portion of the first light 390 is to exit the lightguide structure 324 via a first grating 336 of the lightguide projector 300 and a second portion of the first light 390 is to further propagate through the lightguide structure 324 and exit the lightguide structure 324 via a second grating 336 of the lightguide projector 320. Although FIG. 4G illustrates two light sources 322, any number of light sources 322 (e.g., one light source, more than two light sources, three light sources, four light sources, five light sources, etc.) may be used.

In some examples, a first light source 322 may be coupled to a first lightguide structure 324 that has a first grating portion 336 and a second light source 322 is coupled to a second lightguide structure 324 that has a second grating portion 336. The first grating portion 336 causes first light 390 from the first light source 322 to become a first projected pattern 380 and the second grating portion 336 causes the second light 390 from the second light source 322 to become a second projected pattern 380.

In some examples, a single light source 322 is coupled to a single lightguide structure 324 that has a first grating portion 336 and a second grating portion 336. The single light source 322 may provide first light 390 to the first grating portion 336 to generate a first projected pattern 380. The single light source 322 may provide second light 390 to the second grating portion 336 to generate a second projected pattern 380.

In some embodiments, the lightguide structure 324 has multiple grating portions 336 or a single (e.g., continuous) grating portion 336. The grating portion(s) 336 may be an out-coupling grating that transmits lights 390 from objects in the field of view without disturbance. The grating portion may span over the field of view (FOV) of the cameras 420 without blocking vision of the cameras 420. As the footprint of the grating portion 336 may be small, the grating portion 336 may be located in vicinity to the edge of the lightguide structure 324.

FIG. 4H illustrates a grating portion 336 of a lightguide projector 320, according to some embodiments. In some embodiments, FIG. 4H illustrates grooves of an FGC. Only several grooves are shown for convenience of visibility.

FIG. 4I illustrates a grating portion 336 of a lightguide projector 320. In some embodiments, FIG. 4I illustrates a multispot FGC. Only several curves are presented for convenience of visibility. The inset shows a zoomed-in image of the FGC, separated to sections noted by lines 410, in which the curves within a section are translated in the vertical axis compared to curves in the adjacent sections.

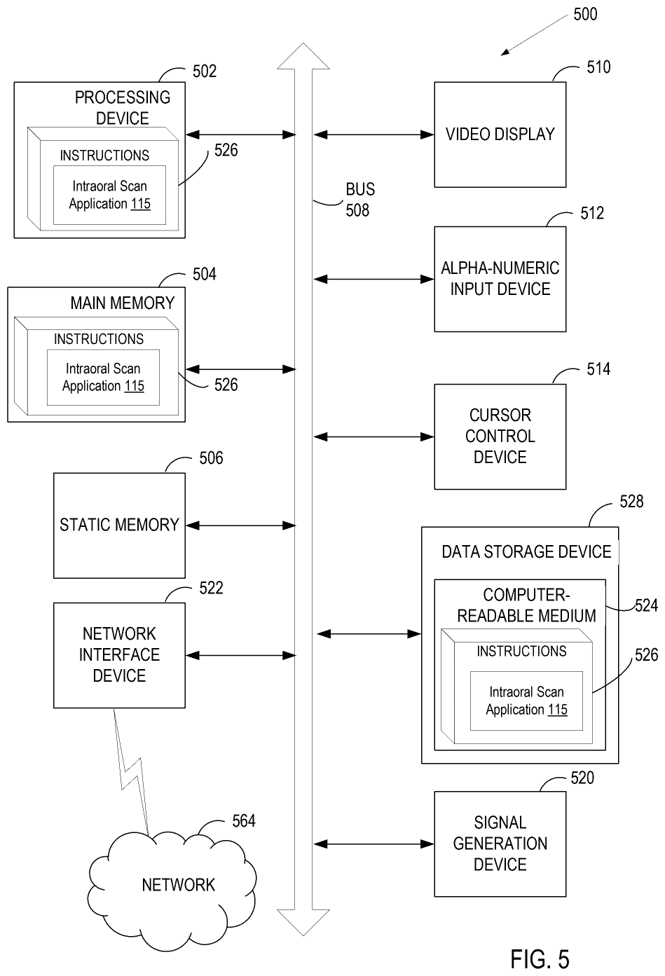

FIG. 5 illustrates a block diagram of an example computing device 500, according to certain embodiments. In some embodiments, FIG. 5 illustrates a diagrammatic representation of a machine in the example form of a computing device 500 within which a set of instructions, for causing the machine to perform any one or more of the methodologies discussed herein, may be executed. In some embodiments, the machine may be connected (e.g., networked) to other machines in a Local Area Network (LAN), an intranet, an extranet, or the Internet. The computing device 500 may correspond, for example, to computing device 105 and/or computing device 106 of FIG. 1. The machine may operate in the capacity of a server or a client machine in a client-server network environment, or as a peer machine in a peer-to-peer (or distributed) network environment. The machine may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The example computing device 500 includes a processing device 502, a main memory 504 (e.g., read-only memory (ROM), flash memory, dynamic random access memory (DRAM) such as synchronous DRAM (SDRAM), etc.), a static memory 506 (e.g., flash memory, static random access memory (SRAM), etc.), and a secondary memory (e.g., a data storage device 528), which communicate with each other via a bus 508.

Processing device 502 represents one or more general-purpose processors such as a microprocessor, central processing unit, or the like. More particularly, the processing device 502 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. Processing device 502 is configured to execute the processing logic (instructions 526) for performing operations and steps discussed herein.

The computing device 500 may further include a network interface device 522 for communicating with a network 564. The computing device 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 520 (e.g., a speaker).

The data storage device 528 may include a machine-readable storage medium (or more specifically a non-transitory computer-readable storage medium) 524 on which is stored one or more sets of instructions 526 embodying any one or more of the methodologies or functions described herein, such as instructions for intraoral scan application 515, which may correspond to intraoral scan application 115 of FIG. 1. A non-transitory storage medium refers to a storage medium other than a carrier wave. The instructions 526 may also reside, completely or at least partially, within the main memory 504 and/or within the processing device 502 during execution thereof by the computing device 500, the main memory 504 and the processing device 502 also constituting computer-readable storage media.

The computer-readable storage medium 524 may also be used to store intraoral scan application 115, which may include one or more machine learning modules, and which may perform the operations described herein above. The computer readable storage medium 524 may also store a software library containing methods for the intraoral scan application 115. While the computer-readable storage medium 524 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium other than a carrier wave that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, and optical and magnetic media.

In some embodiments, the methods, components, and features described herein are implemented by discrete hardware components or are integrated in the functionality of other hardware components such as ASICs, FPGAs, DSPs, or similar devices. In some embodiments, the methods, components, and features are implemented by firmware modules or functional circuitry within hardware devices. In some embodiments, the methods, components, and features are implemented in any combination of hardware devices and computer program components, or in computer programs.

Unless specifically stated otherwise, terms such as “transmitting,” “receiving,” “identifying,” “determining,” “generating,” “providing,” “obtaining,” “causing,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. In some embodiments, the terms “first,” “second,” “third,” “fourth,” etc. as used herein are meant as labels to distinguish among different elements and do not have an ordinal meaning according to their numerical designation.

Examples described herein also relate to an apparatus for performing the methods described herein. In some embodiments, this apparatus is specially constructed for performing the methods described herein or includes a general-purpose computer system selectively programmed by a computer program stored in the computer system. Such a computer program is stored in a computer-readable tangible storage medium.

Some of the methods and illustrative examples described herein are not inherently related to any particular computer or other apparatus. In some embodiments, various general-purpose systems are used in accordance with the teachings described herein. In some embodiments, a more specialized apparatus is constructed to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

The preceding description sets forth numerous specific details such as examples of specific systems, components, methods, and so forth in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

The terms “over,” “under,” “between,” “disposed on,” and “on” as used herein refer to a relative position of one material layer or component with respect to other layers or components. For example, one layer disposed on, over, or under another layer may be directly in contact with the other layer or may have one or more intervening layers. Moreover, one layer disposed between two layers may be directly in contact with the two layers or may have one or more intervening layers. Similarly, unless explicitly stated otherwise, one feature disposed between two features may be in direct contact with the adjacent features or may have one or more intervening layers.

The words “example” or “exemplary” are used herein to mean serving as an example, instance or illustration. Any aspect or design described herein as “example” or “exemplary” is not necessarily to be construed as preferred or advantageous over other aspects or designs. Rather, use of the words “example” or “exemplary” is intended to present concepts in a concrete fashion.

Reference throughout this specification to “one embodiment,” “an embodiment,” or “some embodiments” means that a particular feature, structure, or characteristic described in connection with the embodiment is included in at least one embodiment. Thus, the appearances of the phrase “in one embodiment,” “in an embodiment,” or “in some embodiments” in various places throughout this specification are not necessarily all referring to the same embodiment. In addition, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Also, the terms “first,” “second,” “third,” “fourth,” etc. as used herein are meant as labels to distinguish among different elements and can not necessarily have an ordinal meaning according to their numerical designation. When the term “about,” “substantially,” or “approximately” is used herein, this is intended to mean that the nominal value presented is precise within ±10%.

Although the operations of the methods herein are shown and described in a particular order, the order of operations of each method may be altered so that certain operations may be performed in an inverse order so that certain operations may be performed, at least in part, concurrently with other operations. In another embodiment, instructions or sub-operations of distinct operations may be in an intermittent and/or alternating manner.

It is understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. An intraoral scanner comprising:
a probe housing disposed at a distal end of an elongate wand, the probe housing forming an interior volume; and
a lightguide projector comprising:
a light source configured to generate light, the light source disposed in the interior volume; and
lightguide structure configured to receive the light from the light source, wherein the light is to propagate through the lightguide structure via internal reflections, wherein the lightguide projector is configured to cause the light to exit the lightguide structure to illuminate a mouth of a patient.

2. The intraoral scanner of claim 1 further comprising an in-coupler structure configured to receive the light, wherein the in-coupler structure is disposed between the light source and the lightguide structure.

3. The intraoral scanner of claim 2, wherein the in-coupler structure is one or more of a prism, a diffractive optical element (DOE), or an edge coupler.

4. The intraoral scanner of claim 2 further comprising a lens disposed between the light source and the in-coupler structure, wherein the lens is to focus the light.

5. The intraoral scanner of claim 1 further comprising a micro-lens array (MLA) coupled to the lightguide structure, wherein the MLA is to cause the light to be diffracted and split to an array of spots to be provided into the mouth of the patient.

6. The intraoral scanner of claim 1, wherein the lightguide structure is made of a material that is transparent to the wavelength of the light, wherein the material has a refractive index higher than surrounding environment.

7. The intraoral scanner of claim 1, wherein the lightguide projector comprises a curved mirror that is configured to focus the light substantially perpendicularly to an elongated axis of the lightguide structure and focus the light outside of the lightguide structure.

8. The intraoral scanner of claim 7, wherein the curved mirror is a reflective coating disposed on the lightguide structure.

9. The intraoral scanner of claim 1, wherein the lightguide projector comprises a partially reflecting curved surface embedded within the lightguide structure, wherein the partially reflecting curved surface is configured to cause the light to exit the lightguide structure to illuminate the mouth of the patient.

10. The intraoral scanner of claim 1, wherein:
the lightguide projector comprises a reflecting portion configured to cause the light to exit the lightguide structure to illuminate the mouth of the patient;
the reflecting portion is configured to break the internal reflections of the light within the lightguide structure;
the reflecting portion is at least one of prism or an angle-dependent geometrical structure; and
the reflecting portion is of a different refractive index than the lightguide structure or may be part of the lightguide structure.

11. The intraoral scanner of claim 1, wherein the lightguide projector comprises a grating that is a two-dimensional array of structures integrated within the lightguide structure, wherein the grating is configured to cause the light to exit the lightguide structure to illuminate the mouth of the patient.

12. The intraoral scanner of claim 11, wherein the grating is formed by E-beam lithography, ultraviolet (UV) lithography, nanoimprint, ion doping, or photo-sensitive polymer.

13. The intraoral scanner of claim 11, wherein the grating is a focusing grating coupler (FGC) that is an array of curved and chirped grooves.

14. The intraoral scanner of claim 1, wherein the lightguide projector comprises a grating or a metasurface that is configured to focus the light and split the light into a pattern.

15. The intraoral scanner of claim 11, wherein the lightguide projector comprises:
a second light source configured to provide second light via the lightguide structure to the mouth of the patient.

16. An intraoral scanner comprising:
a probe housing disposed at a distal end of an elongate wand, the probe housing forming an interior volume; and
a lightguide projector comprising:
a light source configured to generate light, the light source disposed in the interior volume, the light being one or more of white light illumination, coherent light illumination, or near-infrared illumination; and
lightguide structure configured to receive the light from the light source, wherein the light is to propagate through the lightguide structure and is to exit the lightguide structure to illuminate a mouth of a patient.

17. The intraoral scanner of claim 16, wherein a reflecting portion of the lightguide projector is configured to focus the light substantially perpendicularly to the elongated axis of the lightguide structure and focus the light outside of the lightguide structure.

18. An intraoral scanner comprising:
a probe housing disposed at a distal end of an elongate wand, the probe housing forming an interior volume; and
a lightguide projector comprising:
a first light source configured to generate first light; and
a second light source configured to generate second light, the first light source and the second light source disposed in the interior volume; and
lightguide structure configured to receive the first light from the first light source and the second light from the second light source, wherein the first light and the second light are to propagate through the lightguide structure via corresponding internal reflections and are to exit the lightguide structure to illuminate a mouth of a patient.

19. The intraoral scanner of claim 18, wherein the first light and the second light are different types of light that have one or more of different wavelengths, different angles, or different spatial distributions.

20. The intraoral scanner of claim 18, wherein the first light is to exit the lightguide structure at a first portion of the lightguide structure, and wherein the second light is to exit the lightguide structure at a second portion of the lightguide structure that is different from the first portion of the lightguide structure.

21. The intraoral scanner of claim 18, wherein a first portion of the first light is to exit the lightguide structure via a first out-coupler of the lightguide projector, and wherein a second portion of the first light is to further propagate through the lightguide structure and exit the lightguide structure via a second out-coupler of the lightguide projector.

22. The intraoral scanner of claim 21, wherein:
the first out-coupler is a first grating, a first metasurface, a first reflecting surface, or a first lens array; and
the second out-coupler is a second grating, a second metasurface, a second reflecting surface, or a second lens array.

23. The intraoral scanner of claim 18, wherein the first light is to exit the lightguide structure at a first portion of the lightguide structure, and wherein the second light is to exit the lightguide structure at the first portion of the lightguide structure.
